(19) United States
(12) Patent Application Publication
(10) Pub. No.: US 2016/0162576 A1
(43) Pub. Date: Jun. 9, 2016

(54) AUTOMATED CONTENT CLASSIFICATION/FILTERING

(71) Applicant: LIGHTNING SOURCE INC., La Vergne, TN (US)

(72) Inventor: Eduardo Ariño de la Rubia, Santa Monica, CA (US)

(73) Assignee: LIGHTNING SOURCE INC., La Vergne, TN (US)

(21) Appl. No.: 14/562,127

(22) Filed: Dec. 5, 2014

(51) Int. Cl. G06F 17/30; G06N 7/00; G06N 99/00

(52) U.S. Cl. CPC G06F 17/30707; G06F 17/30876; G06N 99/005; G06N 7/005

(57) ABSTRACT

Apparatuses, components, methods, and techniques for classifying content are provided. An example method classifies textual content as objectionable. Another example identifies relevant attributes for the content. The example method includes analyzing a body of the content to determine a level of similarity between text in the content and a corpus of predetermined content. The example method further includes upon determining that the level of similarity is greater than a predefined threshold using natural language processing to extract a plurality of features from the content, the features being associated with concepts related to the body of the content. The example method further includes analyzing the extracted features to determine a second level of similarity between the content and the corpus of predetermined content. The example method further includes upon determining that the second level of similarity is greater than a second predefined threshold, classifying the content as objectionable.

### BACKGROUND

Content may be objectionable for many reasons. For example, content may be objectionable because it contains obscenity, hate speech, or political commentary. In some countries, it may be illegal to sell or distribute content that is objectionable. Accordingly, content distributors risk legal problems by selling content that has not been evaluated for objectionable content. However, it may not be practicable for a content producer to evaluate all content in its content catalog, especially if the catalog includes many unique elements of content. As an example of the magnitude of content available, it has been estimated that over 100 million books have been published in the world.

Compounding the difficulties associated with evaluating a large content catalog is the fact that different jurisdictions (e.g., countries, states, etc.) often define content as objectionable based on different standards. Thus an international content distributor faces legal risks by distributing content into a jurisdiction without first evaluating the content against the standards for objectionable content within the jurisdiction. As an additional complication, the standards for objectionable content are ever-changing. Accordingly, a content distributor may need to repeatedly evaluate a large number of elements of content to determine whether they are objectionable in multiple jurisdictions.

Additionally, when dealing with books or other lengthy content, techniques that are used on shorter forms of content are often inadequate or inapplicable. For example, it may be acceptable to flag an entire 140 character message (or even a blog post) as objectionable based on the presence of a particular word or phrase. This approach is less appropriate for larger works of content such as books. Determining whether a book is objectionable may require more thorough analysis of the content as a whole.

### SUMMARY

In general terms, this disclosure is directed to apparatuses, systems, and methods for managing content, and more particularly to an automated apparatuses, systems, and methods for classifying content that enables processing such as filtering content. Various aspects of apparatuses, systems, and methods for classifying content to enable processing such as content filtering are described in this disclosure, which include, but are not limited to, the following aspects.

One aspect is a method of classifying textual content as objectionable. The method comprises analyzing a body of the content to determine a level of similarity between text in the content and a corpus of predetermined content. Upon determining that the level of similarity is greater than a predefined threshold: using natural language processing to extract a plurality of features from the content, the features being associated with concepts related to the body of the content; analyzing the extracted features to determine a second level of similarity between the content and the corpus of predetermined content; and upon determining that the second level of similarity is greater than a second predefined threshold, classifying the content as objectionable.

Another aspect is a method of screening content for objectionable content. The method comprises receiving, by a computing device, the content; determining a jurisdiction that is relevant to the content; analyzing a body of the content to determine a level of similarity between text in the content and a corpus of predetermined content, the predetermined content being objectionable in the jurisdiction; and upon determining the level of similarity is greater than a predefined threshold transmitting a message indicating that the content is objectionable in the jurisdiction.

Another aspect is a system comprising a data store encoded on a memory device. The data store comprises a base classifier and a detailed classifier. The base classifier is trained using examples of objectionable content and examples of non-objectionable content, and the detailed classifier is trained using features extracted from the examples of objectionable content and the examples of non-objectionable content. A computing device is in data communication with the data store. The computing device is programmed to: analyze a body of content using the base classifier to determine a level of similarity between text in the content and the examples of objectionable content. Upon determining that the level of similarity is greater than a predefined threshold the computing device is programed to use natural language processing to extract a plurality of features from the content, the features being associated with concepts related to the body of the content; analyze the extracted features using the detailed classifier to determine a second level of similarity between the content and the examples of objectionable content; and upon determining that the second level of similarity is greater than a second predefined threshold, classify the content as objectionable.

Another aspect is a method of identifying relevant subject codes for content. The method comprises analyzing a body of the content with a plurality of subject code-specific classifiers, wherein each of the subject code-specific classifiers of the plurality are associated with at least one subject code and are configured to determine a level of similarity between text in the content and pre-identified examples of content associated with the at least one subject code; calculating a plurality of subject code scores for the content based on the subject code-specific classifiers; and selecting at least one subject code as relevant based on the plurality of subject code scores.

Another aspect is a method of identifying relevant attributes for content. The method comprises analyzing a body of the content with a plurality of attribute-specific classifiers, wherein each of the attribute-specific classifiers of the plurality are associated with at least one attribute and are configured to determine a level of similarity between text in the content and pre-identified examples of content associated with the at least one attribute; calculating a plurality of attribute scores for the content based on the attribute-specific classifiers; and selecting at least one attribute as relevant based on the plurality of attribute scores.

One aspect is a method of classifying textual content as objectionable. The method comprises analyzing a body of the content to determine a level of similarity between text in the content and a corpus of predetermined content. Upon determining that the level of similarity is greater than a predefined threshold: using natural language processing to extract a plurality of features from the content, the features being associated with concepts related to the body of the content; analyzing the extracted features to determine a second level of similarity between the content and the corpus of predetermined content; and upon determining that the second level of similarity is greater than a second predefined threshold, classifying the content as objectionable.

Another aspect is a method of screening content for objectionable content. The method comprises receiving, by a computing device, the content; determining a jurisdiction that is relevant to the content; analyzing a body of the content to determine a level of similarity between text in the content and a corpus of predetermined content, the predetermined content being objectionable in the jurisdiction; and upon determining the level of similarity is greater than a predefined threshold transmitting a message indicating that the content is objectionable in the jurisdiction.

Another aspect is a system comprising a data store encoded on a memory device. The data store comprises a base classifier and a detailed classifier. The base classifier is trained using examples of objectionable content and examples of non-objectionable content, and the detailed classifier is trained using features extracted from the examples of objectionable content and the examples of non-objectionable content. A computing device is in data communication with the data store. The computing device is programmed to: analyze a body of content using the base classifier to determine a level of similarity between text in the content and the examples of objectionable content. Upon determining that the level of similarity is greater than a predefined threshold the computing device is programed to use natural language processing to extract a plurality of features from the content, the features being associated with concepts related to the body of the content; analyze the extracted features using the detailed classifier to determine a second level of similarity between the content and the examples of objectionable content; and upon determining that the second level of similarity is greater than a second predefined threshold, classify the content as objectionable.

Another aspect is a method of identifying relevant subject codes for content. The method comprises analyzing a body of the content with a plurality of subject code-specific classifiers, wherein each of the subject code-specific classifiers of the plurality are associated with at least one subject code and are configured to determine a level of similarity between text in the content and pre-identified examples of content associated with the at least one subject code; calculating a plurality of subject code scores for the content based on the subject code-specific classifiers; and selecting at least one subject code as relevant based on the plurality of subject code scores.

Another aspect is a method of identifying relevant attributes for content. The method comprises analyzing a body of the content with a plurality of attribute-specific classifiers, wherein each of the attribute-specific classifiers of the plurality are associated with at least one attribute and are configured to determine a level of similarity between text in the content and pre-identified examples of content associated with the at least one attribute; calculating a plurality of attribute scores for the content based on the attribute-specific classifiers; and selecting at least one attribute as relevant based on the plurality of attribute scores.

This summary is provided to introduce a selection of concepts in a simplified form that are further described below in the detailed description. This summary is not intended to identify key features or essential features of the claimed subject matter, nor is it intended that this summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates an exemplary embodiment of a system for automated content filtering and classification.

FIG. 2 illustrates an exemplary architecture of a computing device that can be used to implement aspects of the present disclosure.

FIG. 3 illustrates an exemplary method of filtering content performed by some embodiments of the system of FIG. 1.

FIG. 4 illustrates an exemplary architecture of the server of FIG. 1.

FIG. 5 illustrates an exemplary architecture of the database of FIG. 1.

FIG. 6 illustrates an example format of the database of FIG. 1.

FIG. 7 illustrates an exemplary organizational structure for the classifiers of FIG. 5.

FIG. 8 illustrates an exemplary method of generating classifiers performed by some embodiments of the system of FIG. 1.

FIG. 9 illustrates another exemplary method of generating training corpuses performed by some embodiments of the system of FIG. 1.

FIG. 10 illustrates an exemplary method of generating a Bayesian model performed by some embodiments of the system of FIG. 1.

FIG. 11 illustrates an exemplary method of generating an Ensemble model performed by some embodiments of the system of FIG. 1.

FIG. 12 illustrates an exemplary method of classifying content performed by some embodiments of the system of FIG. 1.

FIG. 13 illustrates an exemplary method of selecting a detailed classifier and classifying content using the selected detailed classifier performed by some embodiments of the system of FIG. 1.

FIG. 14 illustrates another exemplary method of classifying content in blocks performed by some embodiments of the system of FIG. 1.

FIG. 15 illustrates an exemplary method of classifying content using a detail classifier performed by some embodiments of the system of FIG. 1.

FIG. 16 illustrates an exemplary method of processing a request for content performed by some embodiments of the system of FIG. 1.

FIG. 17 illustrates an exemplary method of classifying submitted content performed by some embodiments of the system of FIG. 1.

FIG. 18 illustrates an exemplary method of classifying content using base classifiers for multiple jurisdictions performed by some embodiments of the system of FIG. 1.

FIG. 19 illustrates an exemplary method of classifying content using detail classifiers for multiple jurisdictions performed by some embodiments of the system of FIG. 1.

FIG. 20 illustrates an exemplary architecture of the review station of FIG. 1.

FIG. 21 illustrates an exemplary user interface of the review station of FIG. 1.

FIG. 22 illustrates an exemplary architecture of the system of FIG. 1 for performing classification in parallel.

FIG. 23 illustrates an exemplary method of performing classification in parallel performed by some embodiments of the system of FIG. 1.

FIG. 24 illustrates an exemplary method of performing classification by subject code performed by some embodiments of the system of FIG. 1.

FIG. 25 illustrates an exemplary method of generating subject code-specific classifiers performed by some embodiments of the system of FIG. 1.

FIG. 26 illustrates an exemplary method of classifying content for multiple subject codes performed by some embodiments of the system of FIG. 1.

FIGS. 27A and 27B illustrate another exemplary method of classifying content for multiple subject codes performed by some embodiments of the system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. Use of the terms “or” or “and” means “and/or” unless otherwise stated or expressly implied by the context in which the word is used. The use of “comprise,” “comprises,” “comprising,” “include,” “includes,” and “including” are interchangeable and not intended to be limiting. The terms “such as,” “for example,” “e.g.,” and “i.e.” also are not intended to be limiting. For example, the term “including” shall mean “including, but not limited to.”

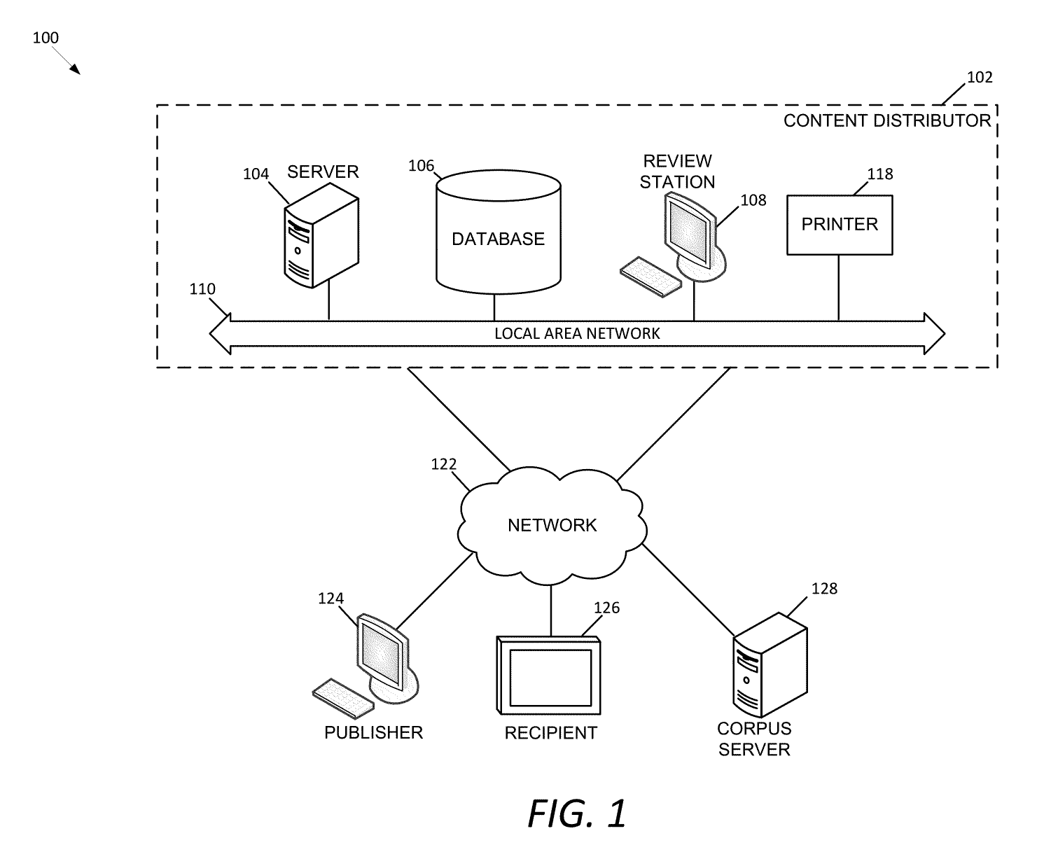

FIG. 1 illustrates an exemplary embodiment of a system 100 for automated content classification and filtering. In general, the system 100 classifies content into one or more classifications. For example, the system 100 can analyze content and then classify some or all of the content according to predetermined classifiers. The system 100 can then filter select content.

The system 100 includes a content distributor 102, a network 122, a publisher computing device 124, a recipient computing device 126, and a corpus server 128. In an example embodiment, the system 100 receives content from the content distributor 102, the publisher computing device 124, or some other source. The system 100 can operate to classify and filter the content for various purposes. For example, the system 100 can classify content as objectionable or not objectionable. In various embodiments, the system 100 classifies content as objectionable based on whether the content contains obscenity, hate speech, political commentary, or other potentially objectionable types of content. The system 100 may filter content by deleting it from the content source, refusing to add the content source to a database or repository of available content, or simply marking the content as unavailable. Alternatively, the system 100 may reject the objectionable content as it is received from the source (e.g., the content distributor 102, the publisher computing device 124, or some other source). Additionally, the system 100 can classify content already stored by the content distributor 102 (e.g., in a database, file system, or elsewhere).

The content distributor 102 operates to perform one or more of storing, classifying, and distributing content. The content distributor 102 includes a server 104, a database 106, a review station 108, a local area network 110, and a printer 118.

The server 104 operates to perform various processes related to classifying content. The server 104 also may operate to perform processes related to managing stored content and distributing the stored content, such as sending the content to the recipient computing device 126 or the printer 118. The server 104 is a computing device that includes a database software application, such as the SQL SERVER® database software distributed by MICROSOFT® Corporation. In at least some embodiments, the server 104 includes a server such as a Web server or a file server. In some embodiments, the server 104 comprises a plurality of computing devices that are located in one or more physical locations. For example, the server 104 can be a single server or a bank of servers.

The database 106 is a data storage device configured to store data representing and related to content and data related to classifying content. In at least some embodiments, the database 106 also stores content. Examples of the database 106 include a hard disk drive, a collection of hard disk drives, digital memory (such as random access memory), a redundant array of independent disks (RAID), optical or solid state storage devices, or other data storage devices. The data can be distributed across multiple local or remote data storage devices. The database 106 stores data in an organized manner, such as in a hierarchical or relational database structure, or in lists and other data structures such as tables. The database 106 can be stored on a single data storage device or distributed across two or more data storage devices that are located in one or more physical locations. The database 106 can be a single database or multiple databases. In at least some embodiments, the database 106 is located on the server 104.

The review station 108 is a computing device configured for reviewing the classification of content. For example, the review station 108 can generate a user interface to allow for the manual review of content that has been classified as potentially objectionable by the server 104. In at least some embodiments, the review station 108 generates a user interface that masks content that has been classified as potentially objectionable. Beneficially, by masking the content, the user who is reviewing the content is not exposed to the objectionable content. In addition, masking the content may be beneficial in jurisdictions where the objectionable content is illegal.

The network 110 communicates digital data between the server 104, the database 106, the review station 108, and the printer 118. The network 110 can be a local area network or a wide area network, such as the Internet. The server 104, the database 106, the review station 108, and the printer 118 can be in the same or remote locations.

The printer 118 is a device for generating printed copies of content. For example, the printer 118 can generate books, pamphlets, magazines, and other types of printed content. The printer 118 is a print-on-demand (POD) printer configured to print small quantities (including only a single copy) of the content as the content is demanded without incurring the setup costs associated with traditional methods, although alternative embodiment can include printers configured to print high volumes of a particular item of content or work. The printer can be sheet fed or web fed and can use various types of available print technology such as laser printing, offset printing, and others.

Other embodiments of the content distributer 102 may include more, fewer, or different capabilities or components than those illustrated in FIG. 1. For example, in alternative embodiments, the content distributer 102 operates to classify content but does not distribute content. In other examples, the content distributor 102 may include a first server and database for classifying content and a second server and database for storing and distributing content. In yet another example, the content distributer does not include a printer 118 or includes multiple printers 118 to provide larger scale production. Additionally, the components disclosed as forming the content distributer 102 (e.g., server 104, database 106, review station 108, a local area network 110) can be located at different facilities, at different geographic location, or even in separate entities.

Similarly, the network 122 communicates digital data between one or more computing devices, such as between the content distributor 102, the publisher computing device 124, the recipient computing device 126, and the corpus server 128. The network 122 can be a local area network or a wide area network, such as the Internet. In at least some embodiments, the network 110 and the network 122 are a single network, such as the Internet.

In at least some embodiments, one or more of the network 110 and the network 122 include a wireless communication system, a wired communication system, or a combination of wireless and wired communication systems. A wired communication system can transmit data using electrical or optical signals in various possible embodiments. Wireless communication systems typically transmit signals via electromagnetic waves, such as in the form of optical signals or radio frequency (RF) signals. A wireless communication system typically includes an optical or RF transmitter for transmitting optical or radio frequency signals, and an optical or RF receiver for receiving optical or radio frequency signals. Examples of wireless communication systems include Wi-Fi communication devices (such as utilizing wireless routers or wireless access points), cellular communication devices (such as utilizing one or more cellular base stations), and other wireless communication devices.

The publisher computing device 124 is a computing device configured to publish content. For example, the publisher computing device 124 can transmit content created by artists, authors, writers, musicians and other content creators to the content distributor 102. In addition, the publisher computing device 124 may transmit archived content to the content distributor 102. The content distributor 102 can then store the content in the database 106. Alternatively, the publisher computing device 124 can transmit content to the content distributor 102 so that the content distributor 102 can classify the content.

The recipient computing device 126 is a computing device configured to receive content. For example, the recipient computing device 126 can request content from the content distributor 102. The content distributor 102 may then transmit the content to the recipient computing device 126 or elsewhere based on the request. For example, if the recipient computing device 126 makes a request for electronic content, the electronic content can be transmitted to the recipient computing device 126 or another computing device (e.g., an e-book reader). Alternatively, if the recipient computing device 126 makes a request for physical content, the content can be transmitted to a geographical location (e.g., a mailing address) included in the request or associated with the recipient computing device 126 or a user of the recipient computing device 126. Additionally, in at least some embodiments, the recipient computing device 126 is associated with at least one jurisdiction. The jurisdiction may be based on the geographic location of the recipient computing device 126, or a geographic location associated with a user of the recipient computing device 126.

In at least some embodiments, one or more of the review station 108, the publisher computing device 124, and the recipient computing device 126 are desktop computer computing devices. Alternatively, one or more of the review station 108, the publisher computing device 124, and the recipient computing device 126 can be laptop computers, tablet computers (e.g., the iPad® device available from Apple, Inc., or other tablet computers running an operating system like a Microsoft Windows® operating system from Microsoft Corporation of Redmond, Wash., or an Android® operating system from Google Inc. of Mountain View, Calif.), smartphones, e-book readers, or other stationary or mobile computing devices configured to process digital instructions. In at least some embodiments, one or more of the review station 108, the publisher computing device 124, and the recipient computing device 126 includes a touch sensitive display for receiving input from a user either by touching with a finger or using a stylus. In at least some embodiments, there are more than one of the review station 108, the publisher computing device 124, and the recipient computing device 126 that are located in one or more facilities, buildings, or geographic locations.

The corpus server 128 operates to perform various processes related to maintaining, storing, or providing corpuses of content. The corpuses of content may include select examples of content known to fall into one or more particular classes. For example, the corpuses might include a collection of content that is representative of objectionable content. In at least some embodiments, that content distributor 102 uses the corpuses of content to generate classification models that can be used to classify content. The corpus server 128 is a computing device and can include a database software application, a Web server, or a file server. In some embodiments, the corpus server 128 comprises a plurality of computing devices that are located in one or more physical locations. For example, the corpus server 128 can be a single server or a bank of servers.

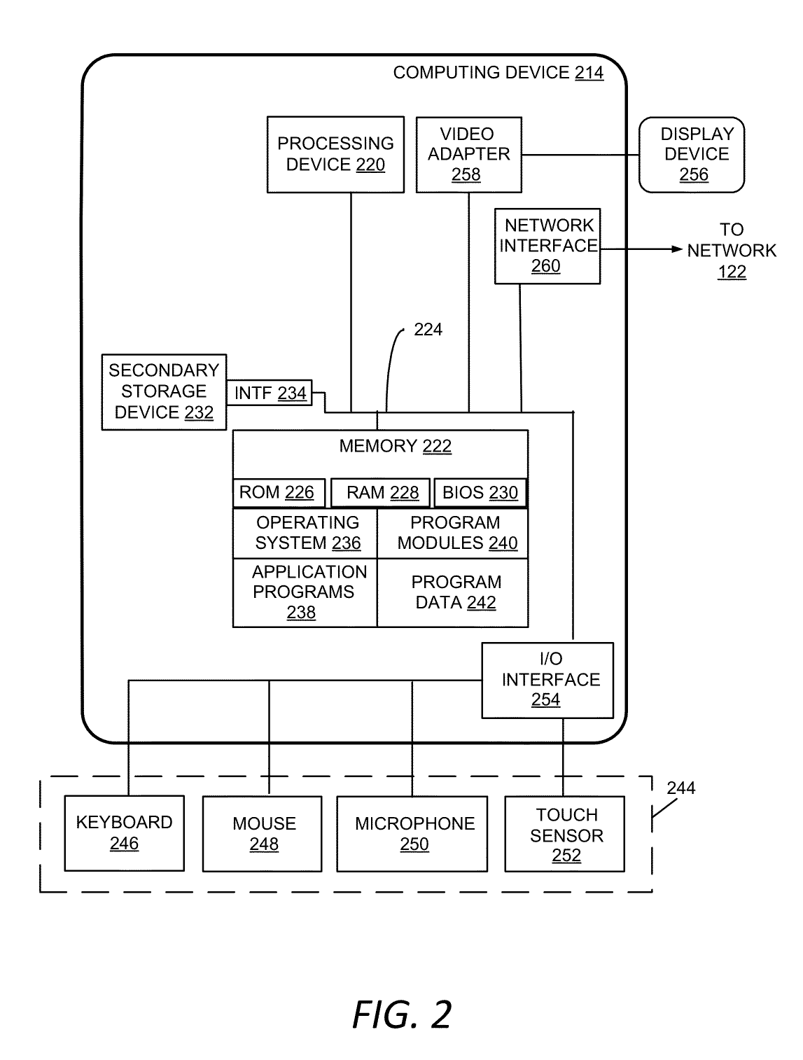

FIG. 2 illustrates an exemplary architecture of a computing device that can be used to implement aspects of the present disclosure, including the server 104, the review station 108, the publisher computing device 124, the recipient computing device 126, and the corpus server 128, and will be referred to herein as the computing device 214. One or more computing devices, such as the type illustrated in FIG. 2, are used to execute the operating system, application programs, and software modules (including the software engines) described herein.

The computing device 214 includes, in some embodiments, at least one processing device 220, such as a central processing unit (CPU) such as a multipurpose microprocessor or other programmable electrical circuit. A variety of processing devices are available from a variety of manufacturers, for example, Intel or Advanced Micro Devices. In this example, the computing device 214 also includes a system memory 222, and a system bus 224 that couples various system components including the system memory 222 to the processing device 220. The system bus 224 is one of any number of types of bus structures including a memory bus or memory controller, a peripheral bus, and a local bus using any of a variety of bus architectures.

The system memory 222 includes read only memory 226 and random access memory 228. A basic input/output system 230 containing the basic routines that act to transfer information within computing device 214, such as during start up, is typically stored in the read only memory 226.

The computing device 214 also includes a secondary storage device 232 in some embodiments, such as a hard disk drive, for storing digital data. The secondary storage device 232 is connected to the system bus 224 by a secondary storage interface 234. The secondary storage devices and their associated computer readable media provide nonvolatile storage of computer readable instructions (including application programs and program modules), data structures, and other data for the computing device 214.

Although the exemplary environment described herein employs a hard disk drive as a secondary storage device, other types of computer readable storage media are used in other embodiments. Examples of these other types of computer readable storage media include magnetic cassettes, flash memory or other solid state memory technology, digital video disks, Bernoulli cartridges, compact disc read only memories, digital versatile disk read only memories, random access memories, or read only memories. Some embodiments include non-transitory media.

A number of program modules can be stored in secondary storage device 232 or memory 222, including an operating system 236, one or more application programs 238, other program modules 240, and program data 242. The database 206 may be stored at any location in the memory 222, such as the program data 242, or at the secondary storage device 232.

The computing device 214 includes input devices 244 to enable the user to provide inputs to the computing device 214. Examples of input devices 244 include a keyboard 246, pointer input device 248, microphone 250, and touch sensor 252. A touch-sensitive display device is an example of a touch sensor. Other embodiments include other input devices 244. The input devices are often connected to the processing device 220 through an input/output interface 254 that is coupled to the system bus 224. These input devices 244 can be connected by any number of input/output interfaces, such as a parallel port, serial port, game port, or a universal serial bus. Wireless communication between input devices 244 and interface 254 is possible as well, and includes infrared, BLUETOOTH® wireless technology, 802.11a/b/g/n, cellular or other radio frequency communication systems in some possible embodiments.

In this example embodiment, a touch sensitive display device 256 is also connected to the system bus 224 via an interface, such as a video adapter 258. The touch sensitive display device 256 includes a sensor for receiving input from a user when the user touches the display or, in some embodiments, or gets close to touching the display. Such sensors can be capacitive sensors, pressure sensors, optical sensors, or other touch sensors. The sensors not only detect contact with the display, but also the location of the contact and movement of the contact over time. For example, a user can move a finger or stylus across the screen or near the screen to provide written inputs. The written inputs are evaluated and, in some embodiments, converted into text inputs.

In addition to the touch sensitive display device 256, the computing device 214 can include various other peripheral devices (not shown), such as speakers or a printer.

When used in a local area networking environment or a wide area networking environment (such as the Internet), the computing device 214 is typically connected to the network through a network interface, such as a wireless network interface 260. Other possible embodiments use other communication devices. For example, some embodiments of the computing device 214 include an Ethernet network interface, or a modem for communicating across the network.

The computing device 214 typically includes at least some form of computer-readable media. Computer readable media includes any available media that can be accessed by the computing device 214. By way of example, computer-readable media include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 214.

Computer readable communication media typically embodies computer readable instructions, data structures, program modules or other data in a data signal. A data signal can be a modulated signal such as a carrier wave or other transport mechanism that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

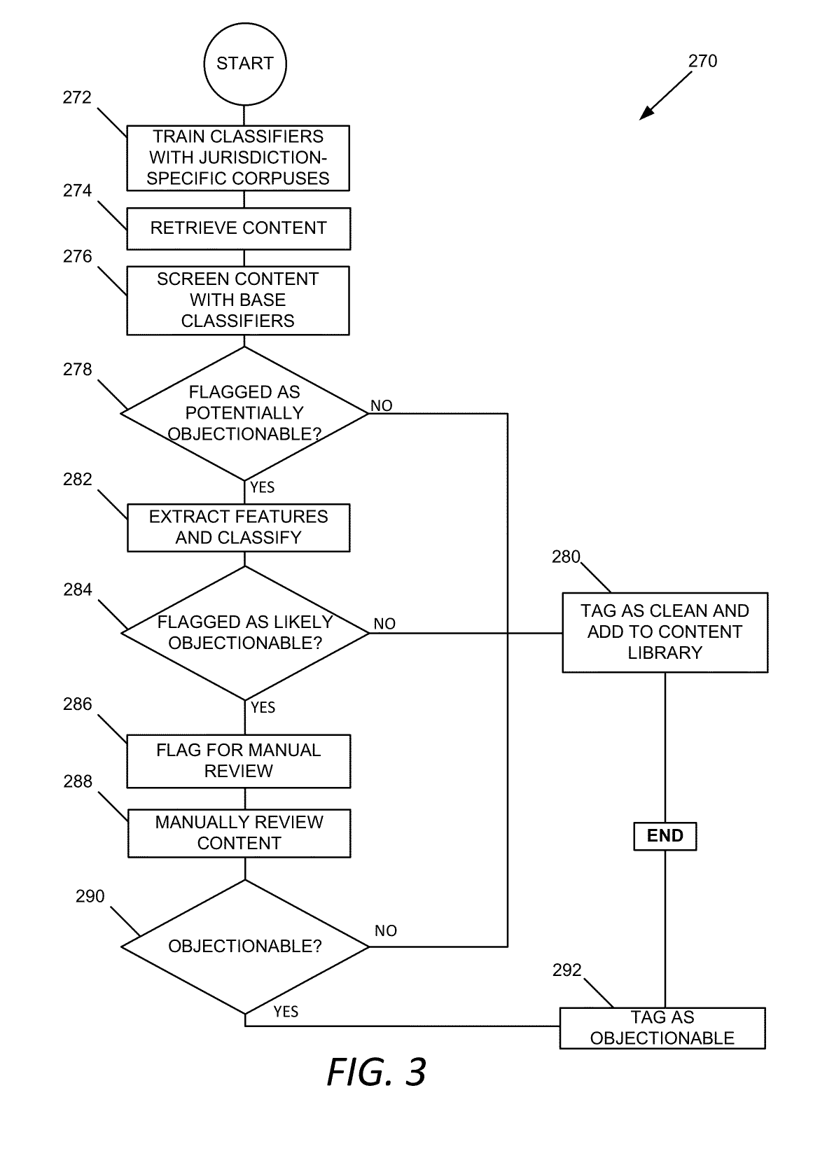

Referring to FIG. 3, different embodiments of the system 100 can classify or categorize content into one or more classes or categories. For example, the system 100 might analyze content and selectively classify content into a single available class such as “not objectionable.” Alternatively, the system 100 might have two or more alternative classes such as “objectionable and not objectionable,” and analyze content to classify it into one of the alternative classes. In yet other embodiments, the system 100 has multiple classes and analyzes content to classify it into one or more of the available classes. An example of this latter embodiment might provide a plurality of classes such as not objectionable, obscene, politically objectionable, hate speech. Another example might provide classes such as Jurisdiction A-not objectionable, Jurisdiction A-obscene, Jurisdiction A-politically objectionable, Jurisdiction B-non objectionable, and Jurisdiction B-obscene. This latter example accommodates different laws and standards in different jurisdictions. The classes can be mutually exclusive such that a particular item of content can be in only one class, or the classes can be non-exclusive such that a particular piece of content can be in two or more classes.

In yet other embodiments, the system 100 can classify content into one or more classes and subclasses. For example, the system 100 might classify content into a superordinate classification of medical or nonmedical, and then classify content in the medical classification into a subordinate class or subclass of either objectionable or not objectionable. This example accommodates different definitions of obscenity depending on whether the content is a medical text or reference or the content is some other genre or work such as fiction. Another example might have a superordinate class for each jurisdiction and then one or more subordinate classes under each jurisdiction class. In various embodiments of systems having different levels of classes, each superordinate class might have the same subordinate classes, have different subclasses, or have different numbers or subclasses. Additionally the system 100 might provide more than two levels of subclasses.

Although this document discloses embodiments of the system 100 classifies and filters textual content as being objectionable or not objectionable, other embodiments are possible. Other embodiments may classify or categorize content on a basis other than whether it is objectionable. For example, embodiments of the system 100 may classify content on the basis of whether it contains classified information or does not contain classified information.

Additionally, the example embodiments disclosed herein analyze textual electronic content for classifying and filtering, although electronic content can include text, images, video, audio, or any combinations thereof (e.g. multimedia content). Possible embodiments may use tools, models, criteria, and techniques other than classifiers or patterns of words to analyze content and determine a class or category for the content. For example, the system 100 might classify or categorize content based on subject matter, such as by determining appropriate Book Industry Subject and Category (BISAC) subject headings, reading level, literary style, author style, theme, language, and various other properties. In some examples, the system 100 is configured to use the current BISAC subject headings or future revisions of the BISAC subject headings. Additionally, the system 100 may be configured to use other subject code classification systems such as the Dewey Decimal Classification as well. Other examples, of alternative tools, models, criteria, and techniques might include bag-of-words models, various pattern recognition models, image recognition, voice recognition and other feature extraction techniques for analyzing and classifying audio and sound waveforms, and others. Embodiments using voice recognition might translate the sound to text for further analysis.

Returning to FIG. 3 an exemplary method 270 of operating the system 100 to classify and filter content includes operations 272, 274, 276, 278, 280, 282, 284, 286, 288, 290, and 292. In some embodiments, the method includes operations that are performed by a processor (such as the processing device 220, shown in FIG. 2).

At operation 272, one or more classifiers are trained with one or more jurisdiction-specific corpuses. The classifiers operate to classify input content into one or more categories, such as objectionable or not objectionable. The classifiers can use various technology to perform classification. Examples of technologies used for classification include Bayesian models, support vector machines, random forests, neural networks, and ensemble methods. Other types of classifier are used in at least some embodiments as well.

A classifier may be trained for each jurisdiction using a jurisdiction-specific corpus. Alternatively, the classifiers may be trained using corpuses that are specific to a particular geographic region. The corpuses contain examples of content that has been already categorized (e.g., manually or otherwise). Often, the corpuses will contain examples of content that is objectionable and examples of content that is not objectionable. Alternatively, separate corpuses of objectionable content and non-objectionable content are used. Conceptually, the training process consists of analyzing the example content to identify features that are useful in distinguishing objectionable content from non-objectionable content. In at least some embodiments, the corpuses include many examples of content that span a plurality of different subject matters. Beneficially, by including many examples that span a plurality of different subject matters, the corpuses minimize the likelihood that the classifiers identify distinguishing features that are actually unrelated to whether the content is objectionable.

Depending on the nature of the content within a corpus, it may be copied in whole or in part to the server 104 or it may be accessed directly on the corpus server 128. Additionally, in at least some embodiments, the content is encrypted so that it is not human readable before it is copied to the server 104. Beneficially, by encrypting the content of the corpus, content that is objectionable is not stored on the server 104 in a manner in which it can be viewed by a person.

In at least some embodiments, base classifiers and detailed classifiers are trained. The base classifiers operate to perform a rough classification of the content as objectionable or not objectionable based on the raw content. Accordingly, the base classifiers may be trained using the raw content of the examples in the corpuses. The detailed classifiers operate to perform classification based on a more detailed analysis of the content. In at least some embodiments, the detailed classifiers operate on features or topics that are extracted from the content rather than on the content directly. Accordingly, the detailed classifiers may be trained based on the features or topics extracted from the content in the corpuses.

Additionally, during the training process, the classifiers can be tuned. For example, because the base classifiers are used a quick screen to identify content that is potentially objectionable, the base classifiers may be tuned to be over inclusive. That is, the base classifiers will occasionally misclassify some content as objectionable even though content is not actually objectionable. This tuning to allow for misclassification allows the base classifiers to operate quickly and imperfectly, while minimizing the potential legal risks of failing to identify obscene content.

After being trained, the classifiers may be stored. For example, the classifiers may be stored in a database system or file system. Additionally, the classifiers may be associated with various attributes, such as a version number, a jurisdiction, and a geographic region. In at least some embodiments, classifiers are associated with more, fewer, or different attributes. In at least some embodiments, operation 272 is not repeated each time the remaining operations in method 270 are executed to classify and filter content. Some embodiments also may enable operation 272 to be executed independently of the remaining operation in the method. For example, operation 272 might be executed for maintenance or to update one or more classifiers to comply with new laws, regulations, standards, user expectations, and the like. At operation 274, the content is retrieved. In some embodiments, the content is encrypted as it is received and before it is stored. If a classifier already exists and is available for use, execution of the method 270 can begin at operation 274.

At operation 276, the content is screened with one or more of the base classifiers. Because the base classifiers operate on the content directly, the base classification process may be performed quickly and without using excessive computational resources. The base classifiers provide a binary result indicating whether the content is classified as objectionable according to the classifier.

At operation 278, it is determined whether the base classifier classified the content as objectionable. If so, the content is considered to be potentially objectionable and the method proceeds to operation 282. If not, the method proceeds to operation 280.

At operation 280, the content is tagged as clean or non-objectionable and added to one or more content libraries. The content may be stored in a database (e.g., database 106) or on a file system such as a file system maintained by server 104. Additionally, various attributes are stored and associated with the content. For example, the date classification was performed and the results of the classification may be stored. Additionally, various properties of the classifiers are stored as well. The properties of the classifiers can include the classifier type (e.g., base or detailed), the classification technology used by the classifier, the jurisdiction or geographic region of the classifier, the version number of the classifier, and the corpus or corpuses and corpus versions used for classifications.

At operation 282, features are extracted from the content and the content is classified using detailed classifiers based on the extracted features. The features may be extracted using natural language processing (NLP) techniques. Alternatively, other techniques are used to extract features from the content. Natural language processing techniques are used by computers to understand, at least in part, the content and meaning of natural language input. Examples of natural language processing techniques include latent semantic analysis (LSA) and latent Dirichlect allocation (LDA). Other natural language processing techniques are used in at least some embodiments as well. Conceptually, these techniques are used to evaluate the content and the language used in the content to identify features (e.g., topics or subject matter to which the content relates) of the content. The topics that are identified may be stored as features of the content. The extracted features may be stored as a list or an array of scores that indicate how strongly the NLP technique associated the content with particular features. Due to the complexity of NLP techniques, this operation may be quite time consuming and computationally intensive.

The features that were extracted are used by the detailed classifiers to classify the content. For example, the extracted features may be from a defined list of features that were also extracted from the content in the corpuses used to train the detailed classifiers. The detailed classifier may determine whether the features extracted from the content are more similar to the features extracted from the example content in the objectionable corpus or the non-objectionable corpus. Alternatively or additionally, the detailed classifier can operate on the content directly to classify it as well. The detailed classifier then generates a Boolean value indicating whether the content is objectionable.

At operation 284, it is determined whether the detailed classifier classified the content as objectionable. If so, the content is considered to be likely objectionable and the method proceeds to operation 286. If not, the method proceeds to operation 280.

At operation 286, the content is flagged for manual review. As an example, the content may be flagged for manual review by adding a record to a database table or updating a value in a preexisting record. Alternatively, the content can be added to a particular directory in a file system. Additionally, the content may be transmitted to the review station 108 for manual review or added to a work queue that is accessible from the review station 108. Because the standards for identifying whether content is objectionable may vary by jurisdiction, the content may be flagged for manual review in one or more particular jurisdictions. In other embodiments, other techniques are used to flag content for manual review.

At operation 288, the content is manually reviewed. In some embodiments, the content is reviewed by a human operator at the review station 108. In at least some embodiments, the content is routed to a one or more particular operators based on the jurisdictions or geographic areas in which the content was considered likely objectionable. By routing the content to particular operators, the operates can develop expertise in identifying objectionable content in particular jurisdictions.

At the review station 108, a portion of the content may be displayed to the operator, so that that the operator can determine whether the content is objectionable. In at least some embodiments, the review station 108 causes a portion of the content being displayed to be masked. If necessary, the operator can request that the mask be removed. However, in some jurisdictions it may be illegal to display the content in an unmasked format. Alternatively, the content can be re-routed to another operator in a different geographic location for additional review if necessary. After the content has been reviewed, the operator can mark the content as not objectionable, objectionable in particular jurisdictions, or objectionable in all jurisdictions.

At operation 290, it is determined whether the operator marked the content as objectionable. If the operator did not mark the content as objectionable in any jurisdictions, the method proceeds to operation 280. If the operator did mark the content as objectionable, the method proceeds to operation 292.

At operation 292, the content is flagged as objectionable. In at least some embodiments, the content is not added to the content library if it is marked as objectionable. Alternatively, if the content is marked as objectionable in only some jurisdictions, the content may still be added to the content library. Additionally, a record may be stored in the content library to indicate that the content is objectionable in certain jurisdictions and should not be distributed in those jurisdictions.

Alternative embodiments of the method 270 are possible. For example, the system 100 could automatically classify and filter documents without providing for manual review as provided in operations 286-290. Another example of alternative embodiments provides for classifying content, but the content is not filtered after classification. In yet another example, the content is analyzed and then filtered without identifying or determining a particular class for the content.

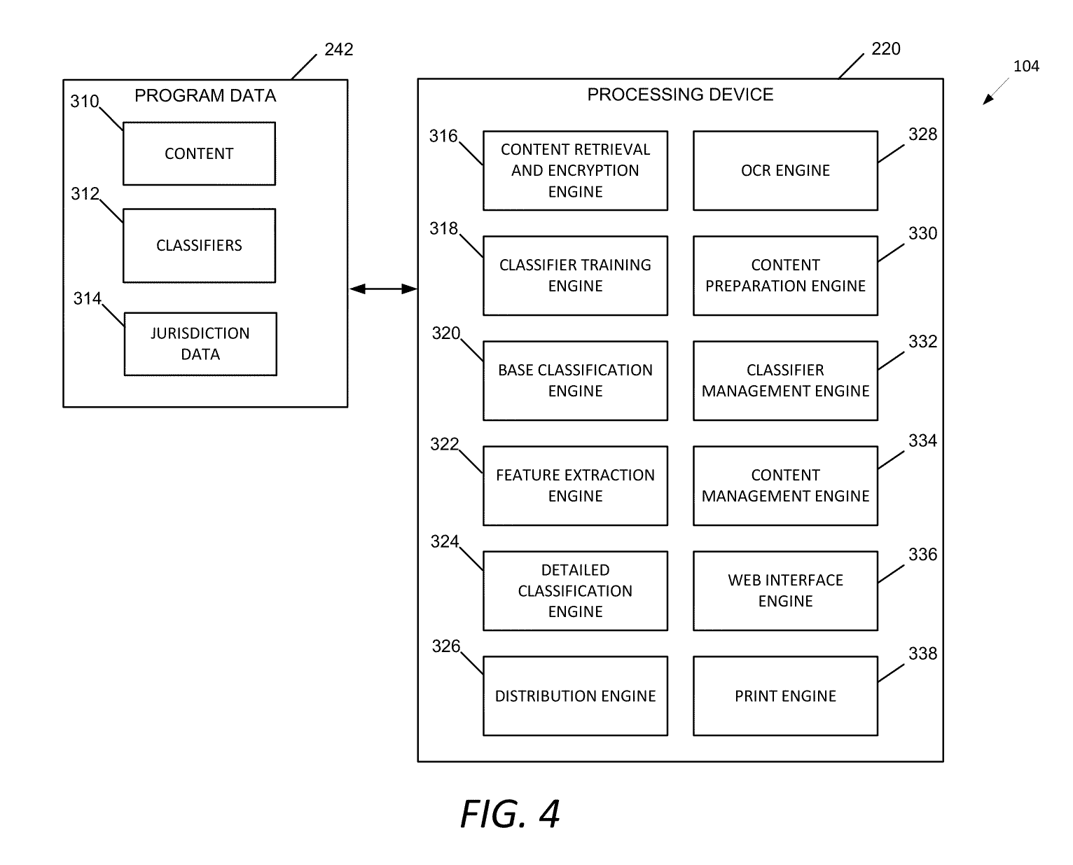

FIG. 4 illustrates an exemplary architecture of the processing device 220 and the program data 242 of the server 104. The processing device 220 is configured to execute a plurality of engines. The engines include a content retrieval and encryption engine 316, a classifier training engine 318, a base classification engine 320, a feature extraction engine 322, a detailed classification engine 324, a distribution engine 326, an OCR engine 328, a content preparation engine 330, a classifier management engine 332, a content management engine 334, a web interface engine 336, and a Print on Demand (POD) engine 338.

Program data 242 is stored in a data storage device, such as the memory 222 or the secondary storage device 232 (shown in FIG. 2). In some embodiments, program data 242 includes content 310, classifiers 312, and jurisdiction data 314. The content 310 may include content that needs to be classified as well as content from the corpuses. Some or all of the content may be encrypted or unencrypted. The classifiers 312 include the classifiers that are used to classify the content and may include a plurality of different versions of classifiers for multiple jurisdictions. The jurisdiction data 314 includes information related to jurisdictions such as the geographical region or regions associated with a jurisdiction and the appropriate classifiers for the jurisdiction.

In an exemplary embodiment, the data stored in program data 242 can be represented in one or more files having any format usable by a computer. Examples include text files formatted according to a markup language and having data items and tags to instruct computer programs and processes how to use and present the data item. Examples of such formats include html, xml, and xhtml, although other formats for text files can be used. Additionally, the data can be represented using formats other than those conforming to a markup language.

The content retrieval and encryption engine 316 operates to retrieve and encrypt content or corpuses containing content. The content retrieval and encryption engine 316 can include an FTP client. Alternatively, the content retrieval and encryption engine 316 uses a different file transfer technology. Additionally, in at least some embodiments, the content retrieval and encryption engine 316 operates to encrypt content as it is received. In at least some embodiments, the content retrieval and encryption engine 316 encrypts the content as it is received using reversible cipher technology so that the content is not stored in a human-readable format. Because one of the purposes of the encryption is to convert the content to a format that is not human readable, many encryption technologies may be used, including those that are quite simple to break. Examples of encryption technology include simple ciphers such as letter substitutions ciphers (e.g., ROT-13) and more complex encryption technology, such as Pretty Good Privacy (PGP), RSA, Data Encryption Standard (DES), Advanced Encryption Standard (AES), Secure Hash Algorithm (SHA) (including SHA-1, SHA-2, SHA-3, and SHA-4), International Data Encryption Algorithm (IDEA), and Blowfish.

The classifier training engine 318 operates to train classifiers. The base classification engine 320 operates to classify content using a base classifier. The feature extraction engine 322 operates to extract features from the content that can be used in classifying the content, such as by the detailed classification engine 324. The detailed classification engine 324 operates to classify the content using a detailed classifier, which in at least some embodiments uses the features extracted by the feature extraction engine 322.

The distribution engine 326 operates to distribute content to consumers or retailers of the content such as the recipient computing device 126. The distribution engine 326 may verify that the content is not objectionable in the applicable jurisdiction or jurisdictions before distributing the content.

The Optical Character Recognition (OCR) engine 328 operates to extract textual data from images. For example, the OCR engine 328 may extract textual data from scanned pages of content. The textual data may then be used to classify the content.

The content preparation engine 330 operates to prepare content for classification. For example, the content preparation engine 330 may remove formatting information and stopwords. The stopwords may include words that appear frequently in the language of the content but are rarely related to the subject matter of the content. For example, in English a, and, or, the, this, that, and which are common stopwords. These words are just examples and often many additional or different stopwords are removed. Removing stopwords can reduce the time and computational resources required to perform classification as the amount of content to be processed is reduced.

The classifier management engine 332 operates to manage classifiers and the data associated with those classifiers. For example, the classifier management engine 332 may store the classifiers in a database, such as database 106, and associate version numbers, corpuses, jurisdictions, and geographic regions with the classifiers.

The content management engine 334 operates to manage content and the data associated with that content. For example, the content management engine 334 may store the content in a database, such as database 106, and associate classification data (e.g., results for particular jurisdictions, classifiers used, date of classification, etc.) with the content.

The web interface engine 336 operates to generate a web interface to the system 100. For example, the web interface engine 336 may operate to generate an interface to receive content and requests for classification of that content. Additionally, the web interface engine 336 may generate an interface to receive requests for a particular content.

The print engine 338 operates to generate physical embodiments (e.g., a paper book) of the content. For example, the print engine 338 may print a single copy of a book after a request is received for the book. In at least some embodiments, the print engine 338 may verify that the content is not objectionable in the applicable jurisdiction or jurisdictions before printing it.

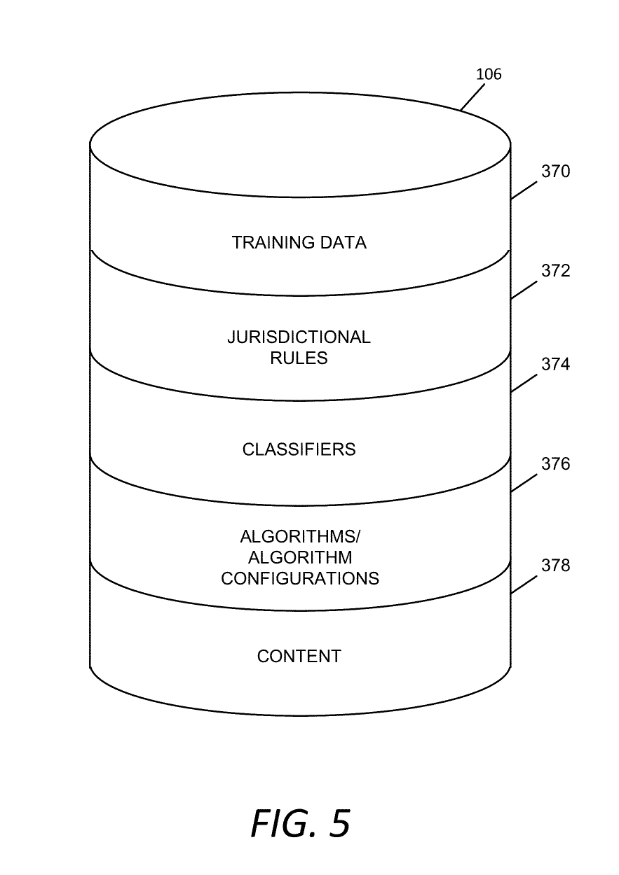

FIG. 5 illustrates an exemplary architecture of the database 106. In this example, the database 106 stores the training data 370, jurisdictional rules 372, classifiers 374, algorithms/algorithm configurations 376, and content 378.

The training data 370 comprises data for use in training the classifiers. Examples of the training data 370 include training corpuses that include examples of objectionable content.

The jurisdictional rules 372 comprise data relating to jurisdictions. Examples of the jurisdictional rules 372 include textual descriptions relating to how content is classified as objectionable in a particular jurisdiction. Beneficially, these textual descriptions may be displayed on user interfaces generated by the review station 108 to provide guidance to a human operator performing classification.

The classifiers 374 comprise the classifiers that are generated to classify the content. The algorithms/algorithm configurations 376 comprise data that is used in classifying the content. The algorithms/algorithm configurations 376 may include the actual instructions or source code that is used to perform classification. Alternatively, the algorithms/algorithm configurations 376 may include parameters (e.g., tuning parameters) that are used by the classifiers.

The content 378 comprises content elements. The content 378 may include content elements that have been classified or that need to be classified. In at least some embodiments, the content 378 is encrypted. The content data may include lengthy, textual content such as books. Alternatively, the content 378 may include shorter textual content, as well as graphic, video, or audio content.

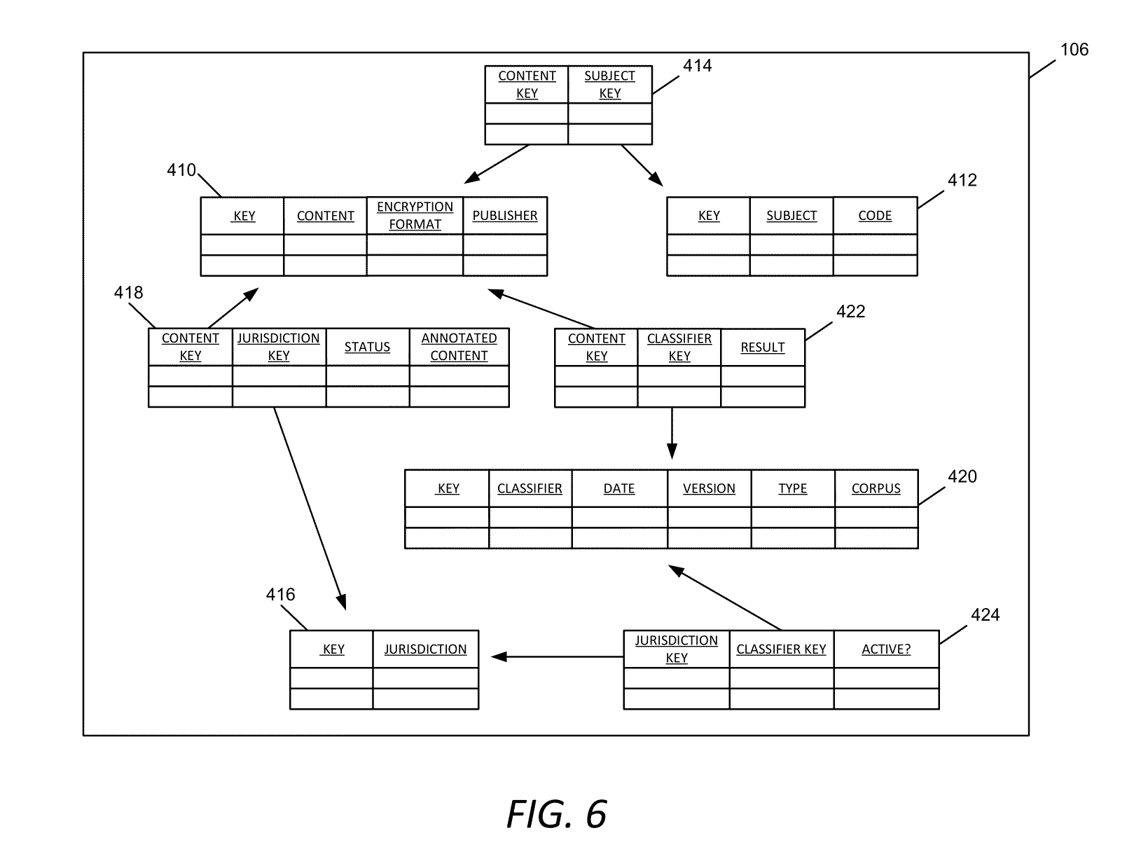

FIG. 6 is an example format of data stored in the database 106 is illustrated. In this example, the data stored in the database 106 is contained in a plurality of data structures in the form of tables utilizing data IDs. Data ID fields are used to map data between tables. Other embodiments include other types of data structures and other methods of linking data structures.

In one example embodiment the data stored in the database 106 includes a content table 410, a subject code table 412, a content-to-subject association table 414, a jurisdiction table 416, a content-to-jurisdiction association table 418, a classifier table 420, a content-to-classifier association table 422, and a jurisdiction-to-classifier association table 424. Additional tables are included in other embodiments as needed. Examples of additional tables include tables to associate subjects with classifiers. Additional or different table structures, such as to merge data from multiple tables into a single table or to separate data from a single table into multiple tables, may be included as well.

The content table 410 includes a list of content and maps each content to a unique key. The key can be used to reference the content in other tables in the database 106 or elsewhere. The content may be stored in the content table 410 as textual or binary data. Alternatively, the content may be stored elsewhere in the database 106 or outside of the database 106. For example, the content may be stored on a local or network file system. The content table 410 may store a string representing a local file path or a uniform resource identifier associated with the content. The content table 410 may also store an encryption format and a publisher associated with the content. The content table 410 may store additional data associated with the content as well. Examples of additional data include available file formats, publication dates, authors, editors, style, genre, ISBN, and other data related to the content.

The subject code table 412 includes a list of subjects and maps each to a unique key. The key can be used to reference the subject in other tables in the database 106 or elsewhere. The subject code table 412 may include a textual description of the subject and a related code. In some embodiments, the subject code table is populated with BISAC codes. However, other embodiments that include other lists of subjects are possible as well. As an example based on BISAC codes, the subject “Ornamental Plants” may be associated with a code of “GAR017000.”

The content-to-subject association table 414 associates the content in the content table 410 with the subjects in the subject code table 412. Each record in the content table 410 may be associated with zero, one, or any other number of subjects in the subject code table 412. In some embodiments, each content record is associated with three subject code records. The records in the content-to-subject association table 414 include the key for a record in the content table 410 and the key for a record in the subject code table 412.

The jurisdiction table 416 includes a list of jurisdictions and maps each jurisdiction to a unique key. The key can be used to reference the jurisdiction in other tables in the database 106 or elsewhere. The jurisdiction may be associated legal authority such as a nation, state, province, city, or other type of legal authority. The jurisdiction may also or alternatively be associated with a geographic region. In some embodiments, geographic regions may be stored in a separate table. The geographic regions are then associated with the jurisdictions. Although jurisdictions having legal authority are described in this example, in other examples, the jurisdictions may be more conceptual and may relate to organizations, institutions, or other entity types.

The content-to-jurisdiction association table 418 associates the content in the content table 410 with the jurisdictions in the jurisdiction table 416. In some examples, content is associated with jurisdictions in which the content is available for distribution. Accordingly, content may be associated with any number of jurisdictions from zero to many. Alternatively, content is associated with the jurisdictions for which the content has been classified. The records in the content-to-jurisdiction association table 418 include the key for a record in the content table 410 and the key for a record in the jurisdiction table 416.

The classifier table 420 includes a list of classifiers and maps each classifier to a unique key. The key can be used to reference the classifier in other tables in the database 106 or elsewhere. The classifiers records may store various data associated with the classifier. For example, the classifier may be stored as a trained classifier (e.g., a matrix of training values, parameters, algorithms, etc.). The classifier table 420 may also store a version number and date associated with a classifier. The date may represent the date the classifier was generated or trained. The version numbers may be used to distinguish classifiers that operate to classify content on the same basis (e.g., obscene in a particular jurisdiction). For example, a new version number may be assigned to a classifier after training using a new corpus or new training algorithm. The classifier table 420 can also store a type value based on the type of classifier that is store (e.g., base, detailed, etc.). The classifier table 420 can also store data related to the corpus used to train the classifier. In some embodiments, the classifier table 420 stores the corpus itself as textual or binary data. Alternatively, the classifier table 420 stores a string representing a local file path or a uniform resource identifier associated with the content. Additionally, various other parameters associated with the classifier may be stored as well. Examples of other parameters include the criteria type identified by the classifier (e.g., obscenity, politically objectionable, hate speech, other objectionable, subject matter, literary style, or other properties of the content), the type of classification technology used (e.g., Bayesian, support vector machine, random forest, ensemble, neural network, and other classification technology).

The content-to-classifier association table 422 associates the content in the content table 410 with the classifiers in the classifier table 420. The records in the content-to-classifier association table 422 include the key for a record in the content table 410 and the key for a record in the classifier table 420. In some examples, content is associated with classifiers that have been used to classify the content. The content-to-classifier association table 422 can also store the result of performing classification on the content using the classifier. For example, the result may be that the content was classified as objectionable by the classifier. Alternatively, the result may be stored as a numeric value indicating the likelihood that the content is objectionable based on the classifier. Other embodiments are possible as well. The content-to-classifier association table 422 may also store additional data related to performing classification using the classifier, such as the date the classification was performed and log files generated by the classification. Beneficially, the log files can be used to evaluate and improve the performance of future classifiers.

The jurisdiction-to-classifier association table 424 associates the jurisdictions in the jurisdiction table 416 with the classifiers in the classifier table 420. The records in the jurisdiction-to-classifier association table 424 include the key for a record in the jurisdiction table 416 and the key for a record in the classifier table 420. In some examples, jurisdictions are associated with classifiers that are configured to classify content for that jurisdiction. For example, one or more classifiers may be configured to classify content as objectionable in a particular jurisdiction. Additionally, the jurisdiction-to-classifier association table 424 can store an active value to indicate that a particular classifier is still appropriate for a jurisdiction and should be treated as active. In some embodiments, if the active field is cleared, the classifier will not be applied for the associated jurisdiction. This can be useful when a new version of a classifier is generated or when a rule change in the jurisdiction occurs rendering the classifier unnecessary.

This example structure of the data of the database 106 illustrated in FIG. 6 is an example of one possible structure. Various other embodiments utilize other data structures and contain more or less data fields as desired. For example, some embodiments include a subject-to-classifier table that associates classifiers with particular subjects in a manner analogous to the jurisdiction-to-classifier association table 424.

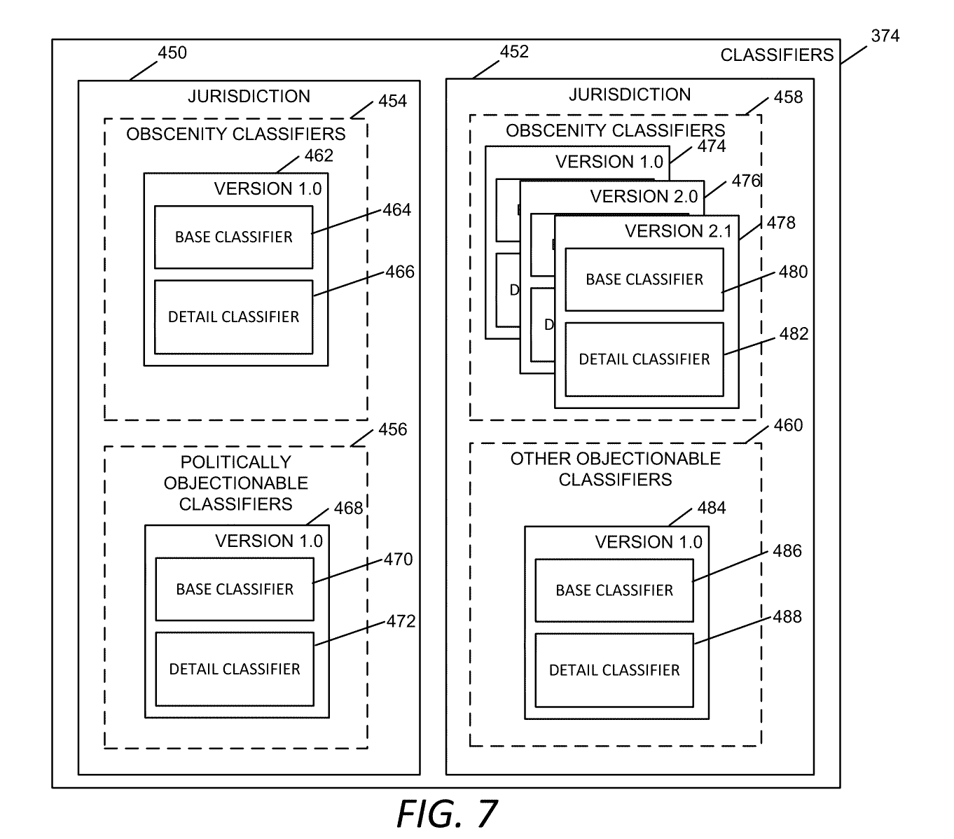

FIG. 7 is a schematic representation of the data associated with the classifiers 374. The data associated with the classifiers may be stored in the database 106 or elsewhere. For example, the data associated with the classifiers may be stored in the classifier table 420. Alternatively or additionally, the data associated with the classifiers may be stored elsewhere or in different data structures.

In this example, the classifiers are organized into two jurisdictions, jurisdiction 450 and jurisdiction 452. Within jurisdiction 450, the classifiers are divided based on classification criteria into two groups, obscenity classifiers 454 and politically objectionable classifiers 456. Similarly, within jurisdiction 452, the classifiers are also divided into two groups, obscenity classifiers 458 and other objectionable classifiers 460.

Within the groups of classifiers, the classifiers are further divided by version number and classification type. For example, obscenity classifiers 454 include a version 1.0 group 462, which includes a base classifier 464 and a detailed classifier 466. Similarly, the politically objectionable classifiers 456 include a version 1.0 group 468, which includes a base classifier 470 and detailed classifier 472.

The obscenity classifiers 458 include a version 1.0 group 474, a version 2.0 group 476, and a version 2.1 group 478. The different versions may correspond to different or revised corpuses that are used for training purposes. Alternatively, the different version may correspond to a change to the rules that define obscenity in jurisdiction 452. For example, a change in the major version number (i.e., from 1.0 to 2.0) may correspond to a change in the rules, while a change in the minor version number (i.e., from 2.0 to 2.1) may correspond to a change in the corpus. The version 1.0 group 474 includes a base classifier and a detailed classifier. Similarly, the version 2.0 group 476 also includes a base classifier and a detailed classifier. The version 2.1 group 478 also includes a base classifier 480 and a detailed classifier 482 as well. Finally, the other objectionable classifiers 460 include a version 1.0, which includes a base classifier 486 and a detailed classifier 488.

The organization of the classifiers shown in FIG. 7 is merely meant to be illustrative. In various embodiments, the classifiers are organized differently. Additionally, the classifiers can be organized into additional jurisdictions, criteria types, and version groups.

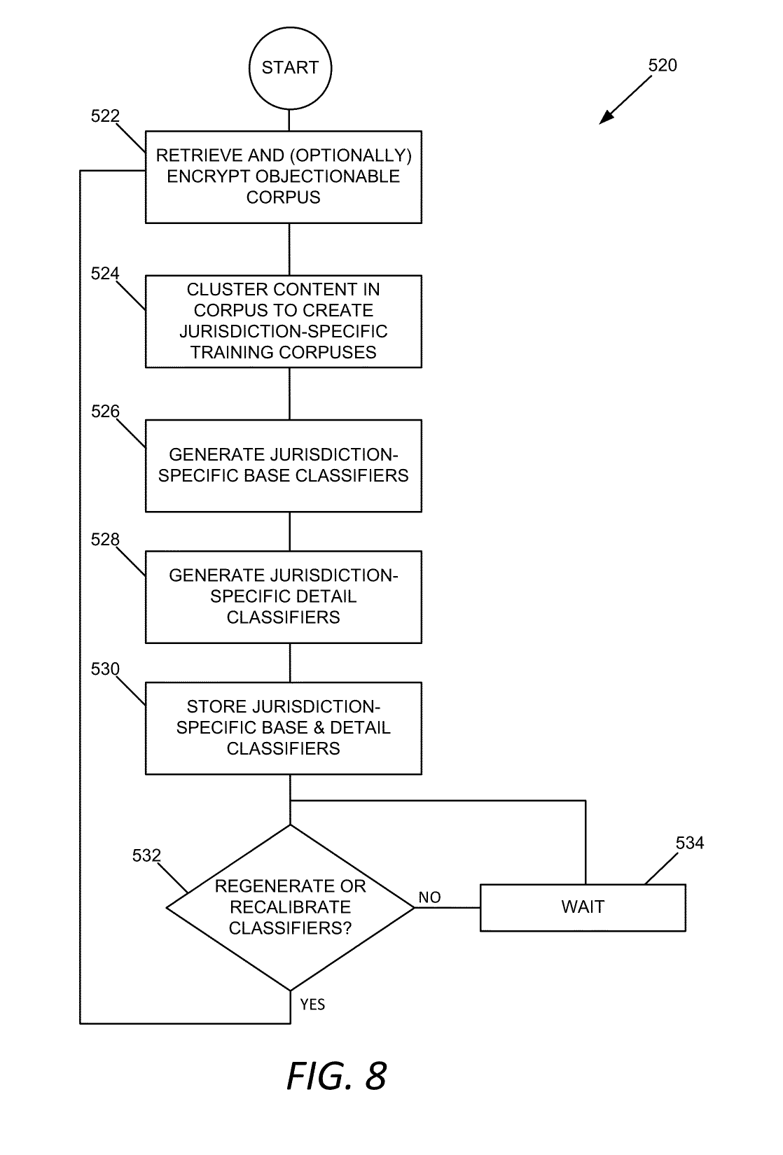

FIG. 8 illustrates an exemplary method 520 of operating the system 100 to generate classifiers. In this example, the method 520 includes operations 522, 524, 526, 528, 530, 532, and 534. In some embodiments, the method includes operations that are performed by a processor (such as the processing device 220, shown in FIG. 2).

At operation 522, an objectionable corpus is retrieved. The objectionable corpus comprises examples of objectionable content. Examples of objectionable content include objectionable documents and excerpts from objectionable documents. The objectionable corpus may be retrieved from the corpus server 128. In some embodiments, the objectionable corpus is encrypted as it is retrieved from the corpus server 128.

At operation 524, the content in the objectionable corpus is clustered. The content may be clustered using any clustering analysis technique. For example, the content may be clustered using k-means clustering, hierarchical clustering, or other clustering analysis techniques for clustering in a sparse feature space (i.e., when most of the features are absent from any particular content example). Alternatively, other or additional clustering analysis techniques can be used as well. Using the clustering analysis technique, the content examples in the objectionable corpus are divided into clusters based on similarity to each other. Depending on the embodiment, the content examples may be assigned to a single cluster or the content examples may be assigned to multiple clusters.

For example, using k-means clustering, the content examples are divided into k number of clusters such that differences between the content examples within each cluster are minimized. In some embodiments, the content examples are clustered so as to minimize the sum of the squared distance between each content example and the mean of all of the content examples in its cluster. The distance between the content examples and the mean of a cluster of content examples can be determined in various ways. As an example, the distance between two content examples can be based on a shared term similarity metric. That is, a pair of content examples that share many terms would be closer together (i.e., the distance between the content examples would be lower) based on the shared term similarity metric than those that share fewer terms. In some embodiments, the shared term similarity metric is calculated between content examples after stop word removal and stemming.

For example, the following three “content examples” will be used to demonstrate an example method of calculating the distance between content examples.
a: I like to eat potatoes. Potatoes are delicious.
b: The Irish Potato Famine was terrible. Many lives were lost.
c: Delicious Irish meals, such as potato based dishes, are fantastic to eat when a family is feeling famished.
   After stop word removal and stemming, the following matrix-like data structures can be produced:
a: {like: 1; eat: 1; potato: 2; delicious 1};
b: {Irish: 1; potato: 1; famine: 1; terrible: 1; life: 1; lost: 1}; and
c: {delicious: 1; Irish: 1; meal: 1; potato: 1; dish: 1; fantastic: 1; eat: 1; family: 1; famine: 1}.

The distance metric can then be calculated using these matrix-like data structures. So, the distance between content examples a and b can be based on having one word in common (potato) and eight words that are not in common (three in a and five in b); the distance between content examples a and c would be based on having three words in common (eat, potato, and delicious) and seven words that are not in common (one in a and six in c); and the distance between content examples b and c would be based on having two words in common (Irish and potato) and eleven words that are not in common (four in b and seven in c). This is a simplified example to illustrate the concept. In some embodiments, the content examples are treated as data points in a high-dimension space (e.g., each term corresponds to a dimension in that space). Additionally, rather than using word counts, the terms can be represented in the matrix-like data structures using term frequency-inverse document frequency (tf-idf). Term frequency-inverse document frequency can be used to generate a metric or number that represents the importance of the term to the content example. Other techniques to generate a metric or number to represent the importance of a term to a document can be used as well. In some embodiments, the mean of a cluster is calculated by averaging the term matrix values for each of the content examples in the cluster.

The clusters of content examples can then be reviewed (e.g., by a human expert) to identify whether the content in the cluster is objectionable in a particular jurisdiction. If the cluster is determined to contain objectionable content within a particular jurisdiction, the cluster can be tagged as objectionable. In this manner, the content clusters can be fine-tuned to fit each jurisdiction. This may be beneficial as objectionable content may be perceived differently in different jurisdictions. In some embodiments, the tagged clusters are then combined to form jurisdiction-specific training corpuses.

At operation 526, jurisdiction-specific training corpuses are used to generate jurisdiction-specific base classifiers. In some embodiments, the base classifier is a naïve Bayesian classifier and is trained using the jurisdiction-specific training corpuses. In addition to the jurisdiction-specific corpuses, the naïve Bayesian classifier may be trained using examples of non-objectionable content as well. In some embodiments, the content examples from the clusters that were not tagged as objectionable are used in training the naïve Bayesian classifier as well. These examples of content may be used as non-objectionable content which the naïve Bayesian classifier is trained to distinguish from the content examples in the tagged clusters. Alternatively or additionally, examples of non-objectionable content may be retrieved from other sources as well such as content that has been previously approved or distributed without issue in the jurisdiction.

At operation 528, jurisdiction-specific training corpuses are used to generate jurisdiction-specific detailed classifiers. In some embodiments, the jurisdiction-specific detailed classifier is a support vector machine. Other classification technology can be used as well. The detailed classification comprises extracting features from the content examples in the jurisdiction-specific training corpuses. The extracted features are then used in training the detailed classifiers. Like the process of training the base classifiers, the detailed classifiers may also be trained using examples of non-objectionable content such as the examples in the clusters that were not tagged as objectionable or other examples of non-objectionable content. Features are also extracted from examples of non-objectionable content as well. The jurisdiction-specific detailed classifier is then trained to best distinguish the examples of content in the jurisdiction-specific training corpuses from the examples of non-objectionable content based at least in part on the extracted features.

At operation 530, the jurisdiction-specific base and detailed classifiers are stored. These classifiers can be stored for example in the database 106. Alternatively, these classifiers can be stored elsewhere, such as in a directory on a file system that is not associated with a database. The classifiers may be stored with various associated data such as the data described with respect to classifier table 420.

At operation 532, it is determined whether the classifiers need to be regenerated or recalibrated. For example, the classifiers may be regenerated due to changes in the objectionable corpus or changes in the rules governing objectionable content in a particular jurisdiction. Additionally, the classifiers may be recalibrated by modifying parameters associated with the classifier. For example, a classifier may classify content as objectionable when a particular score is achieved. A parameter can be modified to raise or lower the score and thus make the classifier more or less inclusive. If it is determined that the classifier needs to be regenerated or recalibrated, the method returns to operation 522. However, in some embodiments recalibration may be performed by storing updated parameters (i.e., it may not be necessary to return to operation 522 and repeat the method). If, it is determined that it is not necessary to regenerate or recalibrate the classifiers, the method continues to operation 534.

At operation 534, the method waits. The method may wait for a particular period of time to occur or a particular event to happen. After waiting, the method returns to operation 532 to determine whether the jurisdiction-specific classifiers should be regenerated or recreated. In some embodiments, the method 520 waits for a one day, one month, six months or a year. Alternatively, the method 520 monitors the objectionable corpus until it is changed. As yet another alternative, the method 520 waits for instructions from an operator.

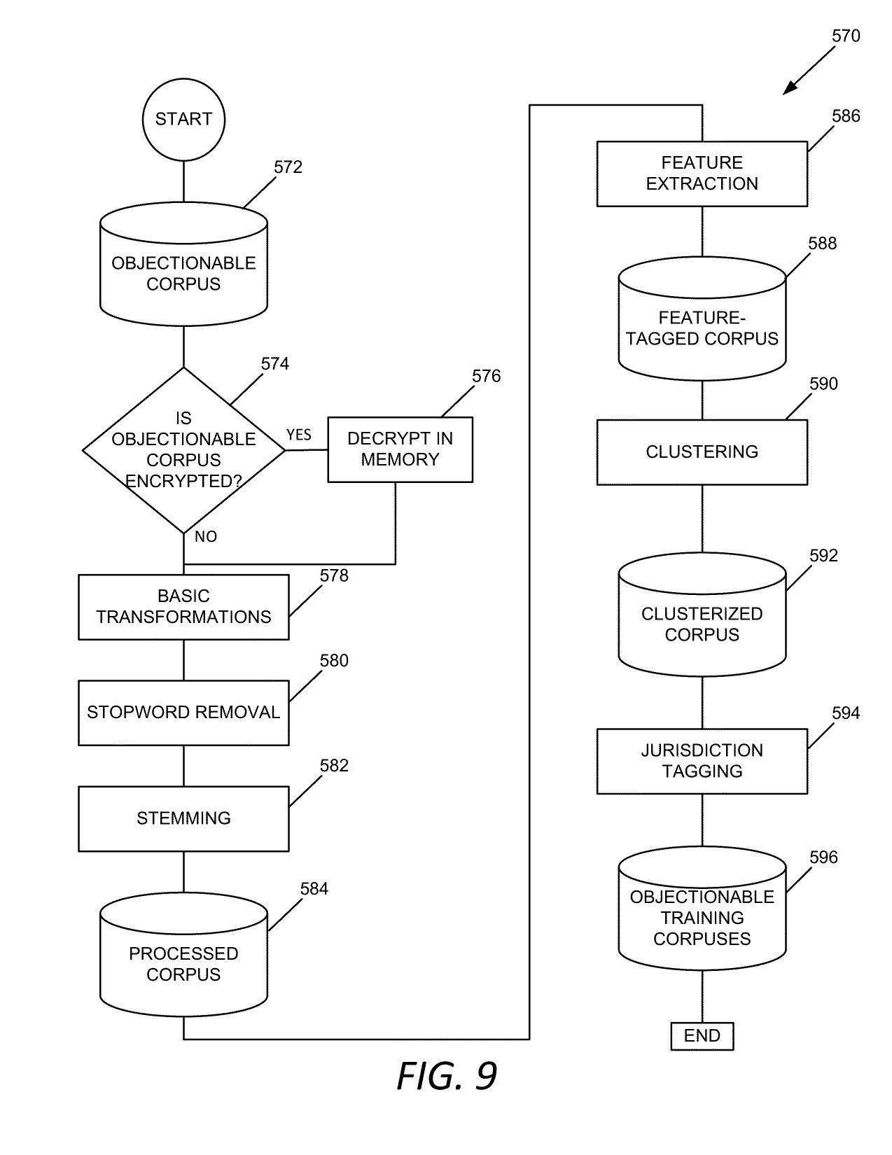

FIG. 9 illustrates an exemplary method 570 of operating the system 100 to generate training corpuses. In this example, the method 570 uses an objectionable corpus 572 to generate a processed corpus 584, a feature-tagged corpus 588, a clusterized corpus 592, and objectionable training corpuses 596. In this example, the method 570 includes operations 574, 576, 578, 580, 582, 586, 590, and 594. In some embodiments, the method includes operations that are performed by a processor (such as the processing device 220, shown in FIG. 2).

The objectionable corpus 572 may contain examples of content that may be objectionable in one or more jurisdiction. In some embodiments, the objectionable corpus 572 may also contain examples of content that are not necessarily objectionable. For example, the objectionable corpus 572 may contain examples of content that have been misidentified as objectionable.

At operation 574, it is determined whether the objectionable corpus 572 is encrypted. If the objectionable corpus 572 is encrypted, the method 570 proceeds to operation 576. If instead the objectionable corpus 572 is not encrypted, the method 570 proceeds to operation 578.

At operation 576, the objectionable corpus 572 is decrypted in memory. In some embodiments, only a portion of the content in the objectionable corpus 572 is decrypted at a time. Alternatively, all of the content in the objectionable corpus 572 is decrypted in memory.

At operation 578, basic transformations are performed on the content of the objectionable corpus 572. The basic transformations prepare content for later processing. Examples of basic transformation include performing optical character recognition (when necessary), converting uppercase textual content to lowercase or vice-versa, removing formatting information, standardizing spelling of words, and removing or replacing some or all punctuation. Additional examples may include converting images and video to a standard resolution, color space, and format. Some embodiments do not perform all of the basic transformations described above. Additionally, some embodiments perform additional or different steps to prepare content for later processing.

At operation 580, stopwords are removed from the content. Examples of stopwords and techniques for stopword removal discussed herein.

At operation 582, stemming is performed. Stemming includes converting at least some words to a base or root word or nonword (i.e., a stem). For example, the words jumps, jumping, and jumped may all be converted to the word jump. As another example, the words rattle, rattled, and rattling may all be converted to the nonword rattl (alternatively, these words could be converted to the word rattle). These are just examples, and in some embodiments, the operation 582 may convert these example words to different stems. Stemming can be performed using various techniques. For example, stemming may be performed using a dictionary that maps words to stems words. Alternatively, stemming may be performed by removing recognized suffixes or prefixes from words. Further, in some embodiments, a combination of these techniques is used. Other embodiments are possible as well.

The processed corpus 584 is generated by operation 582 and contains the content from the objectionable corpus 572 after operations 578, 580, and 582 have been performed. In some embodiments, the processed corpus 584 is stored to reduce future processing time. Further, the processed corpus 584 may be encrypted before being stored.

At operation 586, features are extracted from the content. As has been described above, the features may be extracted using natural language processing (NLP) techniques such as latent semantic analysis (LSA) and latent Dirichlect allocation (LDA). Other natural language processing techniques are used in at least some embodiments as well. These techniques evaluate the content and the language used in the content to identify features of the content (e.g., topics or subject matter to which the content relates).

The feature-tagged corpus 588 is generated by operation 586. In some embodiments, each content example in the corpus is associated with a list of extracted features. Additionally, the features in the list may also be associated with a score or other value indicating how strongly associated a particular feature is to the content. The feature-tagged corpus 588 may be stored in an encrypted or decrypted format. Alternatively, the feature-tagged corpus 588 may be stored temporarily in memory and may be removed after method 570 is complete.

At operation 590, the content is clustered. Clustering is performed to group the content into clusters of content that are similar to each other. As described above, many techniques can be used to perform clustering. The content may be clustered based on the extracted features stored in the feature-tagged corpus 588. In some embodiments, a particular content example is associated with a single cluster. Alternatively, content examples may be associated with multiple clusters.

The clusterized corpus 592 is generated by operation 590. The content examples in the clusterized corpus 592 may be associated with particular clusters. Alternatively, the clusterized corpus 592 may be stored as multiple separate sub-corpuses. The clusterized corpus 592 may be stored for use outside of the method 570. Alternatively, the clusterized corpus 592 is stored in memory temporarily and is removed after the method 570 completes.

At operation 594, the clusters in the clusterized corpus 592 are tagged for one or more jurisdictions to indicate whether the content is objectionable within those jurisdictions. As described above, this operation may be performed by a human operator who is trained in the particular standards for objectionable content in a particular jurisdiction. Other embodiments are possible as well. Each of the clusters may be tagged as being objectionable or not objectionable in one or more jurisdictions.

The objectionable training corpuses 596 are generated by operation 594. The objectionable training corpuses 596 may include examples of objectionable content in a specific jurisdiction. The objectionable training corpuses 596 are examples of jurisdiction-specific training corpuses. The objectionable training corpuses 596 may be stored in an encrypted or unencrypted format for later use in training classifiers.

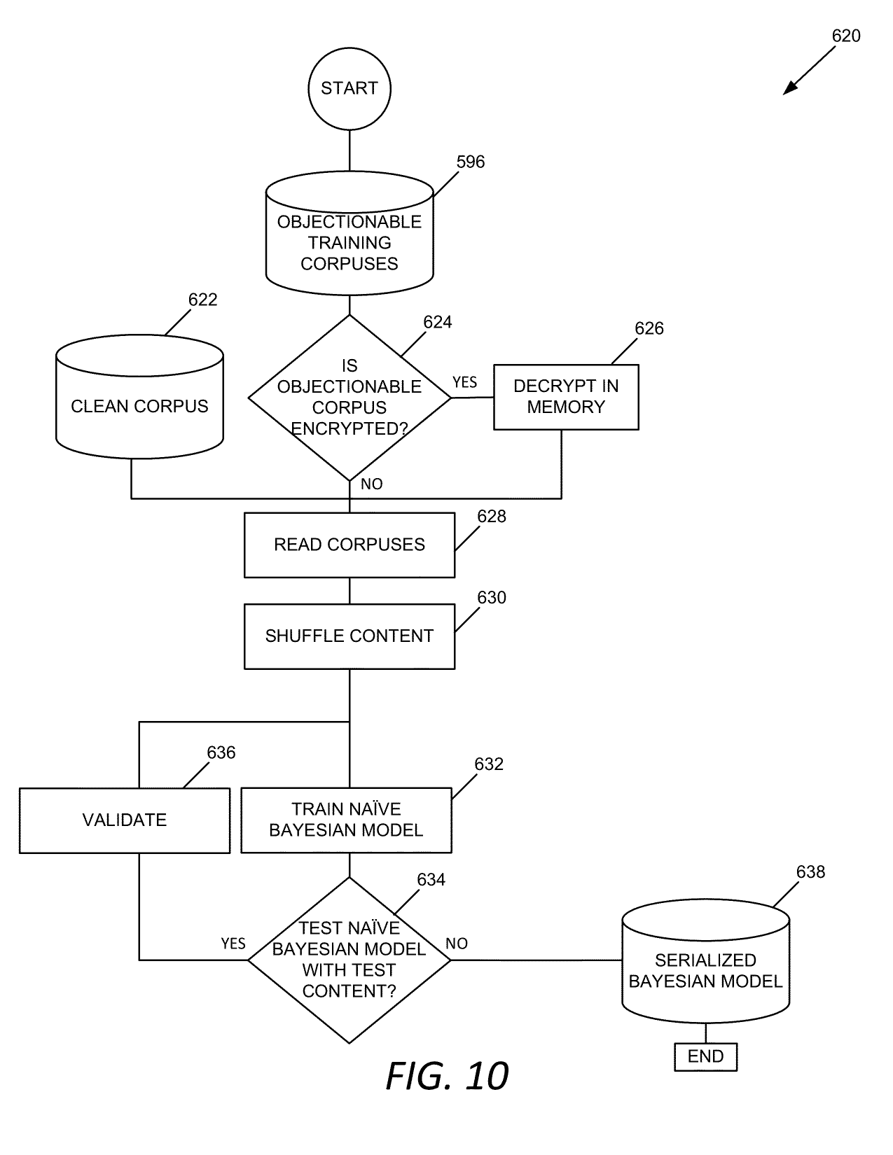

FIG. 10 illustrates an exemplary method 620 of operating the system 100 to generate base classifiers. In this example, the method 620 uses the objectionable training corpuses 596 and a clean corpus 622 to generate a serialized Bayesian model 638. In this example, the method 620 includes operations 624, 626, 628, 630, 632, 634, and 636. In some embodiments, the method includes operations that are performed by a processor (such as the processing device 220, shown in FIG. 2).

The clean corpus 622 may contain examples of content that has been identified as not being objectionable. The clean corpus 622 may contain content that is not objectionable in all jurisdictions. Alternatively, the clean corpus 622 may be jurisdiction-specific, containing content that has been determined to not be objectionable in a specific jurisdiction.

At operation 624, it is determined whether the objectionable training corpuses 596 are encrypted. If the objectionable training corpuses 596 are encrypted, the method 620 proceeds to operation 626. If instead the objectionable training corpuses 596 are not encrypted, the method 620 proceeds to operation 628.

At operation 626, the objectionable training corpuses 596 are decrypted in memory. In some embodiments, only a portion of the content in the objectionable training corpuses 596 is decrypted at a time. Alternatively, all of the content in the objectionable training corpuses 596 is decrypted in memory.

At operation 628, the objectionable training corpuses 596 and the clean corpus 622 are read.

At operation 630, the content is shuffled. Shuffling the content may involve dividing the content into segments (such as paragraphs, pages, chapters, books, etc.).

At operation 632, the shuffled content is used to train a naïve Bayesian model. The naïve Bayesian model is trained to distinguish the content examples in the clean corpus 622 from the content example in the objectionable training corpuses 596.

At operation 634, it is determined whether the trained naïve Bayesian model should be tested on test content. The test content may include identified examples of content that is both objectionable and clean (i.e., non-objectionable) that was not used during training in operation 632. The test content may be extracted from the objectionable training corpuses 596 and the clean corpus 622 before operation 632 is performed. Alternatively, the test content may come from one or more separate test corpuses. If the naïve Bayesian model is to be tested on test content, the method proceeds to operation 636. Otherwise the method ends and the trained naïve Bayesian model is stored as the serialized Bayesian model 638.

At operation 636, the naïve Bayesian model is validated by performing classification on the test content. The naïve Bayesian model may be validated using cross-validation (e.g., k-fold cross validation). Because the test content has been previously identified as clean or objectionable, the performance of the naïve Bayesian model can be evaluated. Depending on the circumstances, the performance of the naïve Bayesian model can be evaluated based on one or more of the percentage of content examples from the test content that are accurately classified, the percentage of objectionable examples that are correctly identified, and the percentage of clean examples that are correctly identified. Other embodiments are possible as well.

After operation 636, the method may return to operation 632 to retrain the naïve Bayesian classifier. In some embodiments, more training data may be provided or training parameters may be adjusted. However, in some instances, the method 620 ends after operation 636, such as when the validation process indicates that the naïve Bayesian classifier classifies example test content with an accuracy above a predefined threshold.

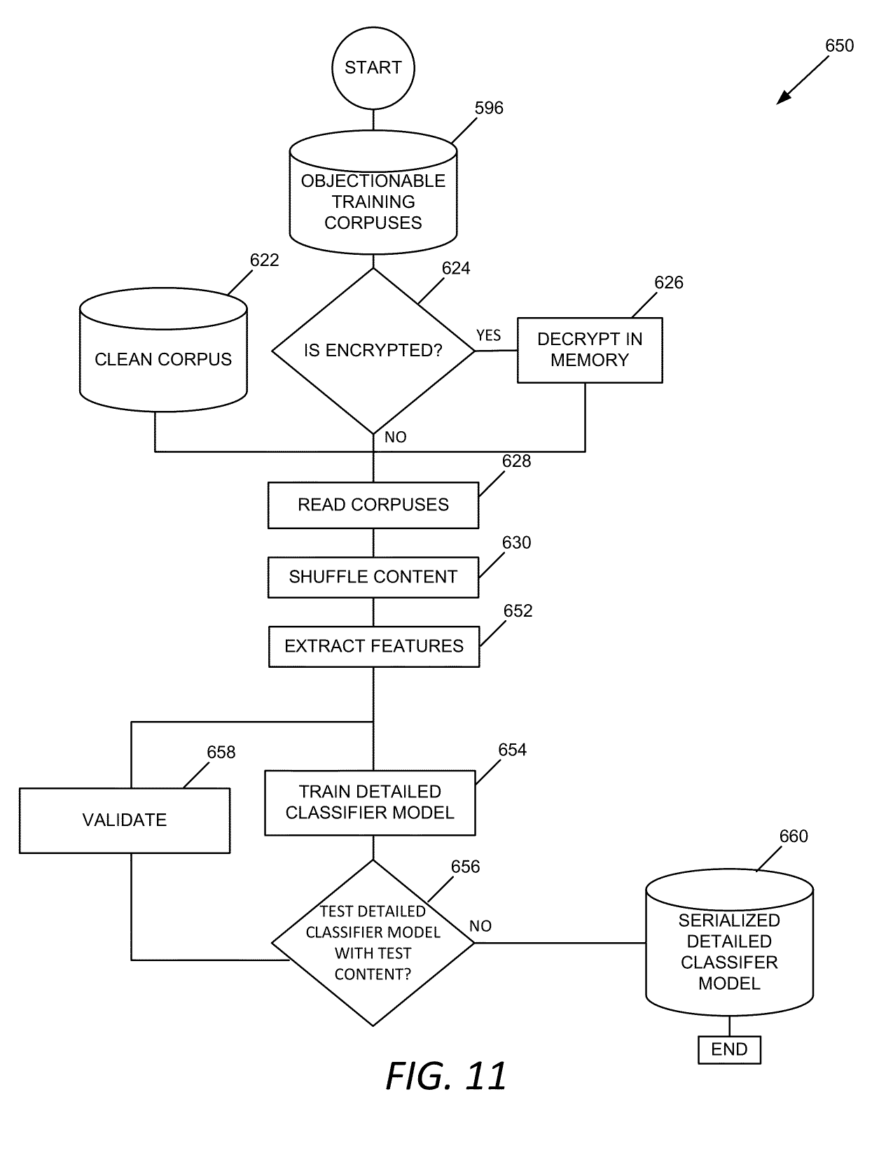

FIG. 11 illustrates an exemplary method 650 of operating the system 100 to generate detailed classifiers. In this example, the method 650 uses the objectionable training corpuses 596 and the clean corpus 622 to generate a serialized detailed classifier model 660. In this example, the method 650 includes the operations 624, 626, 628, 630, 632, as well as operations 654, 656, and 658. In some embodiments, the method includes operations that are performed by a processor (such as the processing device 220, shown in FIG. 2).

The objectionable training corpuses 596 and clean corpus 622 are processed by operations 624, 626, 628, and 630, which are described above. At operation 652 features are extracted from the segments of the content examples produced by operation 630. Features can be extracted using the feature extraction techniques described above or other feature extraction techniques. Features are extracted from the examples in the objectionable training corpuses 596 and the clean corpus 622.

At operation 654, the detailed classifier model is trained. The detailed classifier model may be trained at least in part using the features extracted in operation 652. The detailed classifier model is trained to distinguish the content examples in the clean corpus 622 from the content example in the objectionable training corpuses 596 based at least in part on the features extracted by operation 652. The training may involve determining weighting values for the extracted features and a threshold value such that when the weighting factors are applied to the features of a content example and summed, the resulting number can be compared to the threshold to determine whether the content example is objectionable or clean. Alternatively or additionally, the training process may involve identifying one or more representative content examples from the clean corpus 622 and the objectionable training corpuses 596 that are most representative of objectionable or clean content. The model may then classify content based on whether the content is more similar to the identified representative content examples from the clean corpus 622 or the objectionable training corpuses 596. Other technologies can be used as well. Examples of technologies used for detailed classification include Bayesian models, support vector machines, random forests, and ensemble methods. Further, some embodiments combine one or more of these techniques or use entirely different techniques as well.

At operation 656, it is determined whether the trained detailed classifier model should be tested on test content. This operation is similar to operation 632, except that it operates on the detailed classifier model rather than the naïve Bayesian model. If the detailed classifier model is to be tested on test content, the method 650 proceeds to operation 658. Otherwise the method ends and the trained detailed classifier is stored as the serialized detailed classifier model 660.

At operation 658, the detailed classification model is validated by performing classification on the test content. This operation is similar to operation 636, except that it validates the trained detailed classifier model by classifying test content examples using the trained detailed classifier model.

After operation 658, the method may return to operation 654 to retrain the detailed classifier model. In some embodiments, more training data may be provided or training parameters may be adjusted. However, in some instances, the method 650 ends after operation 658, such as when the validation process indicates that the detailed classifier classifies example test content with an accuracy above a predefined threshold. In some embodiments, the threshold for the detailed classifier may be different (e.g., higher or lower) than the threshold used to determine whether the naïve Bayesian classifier is trained.

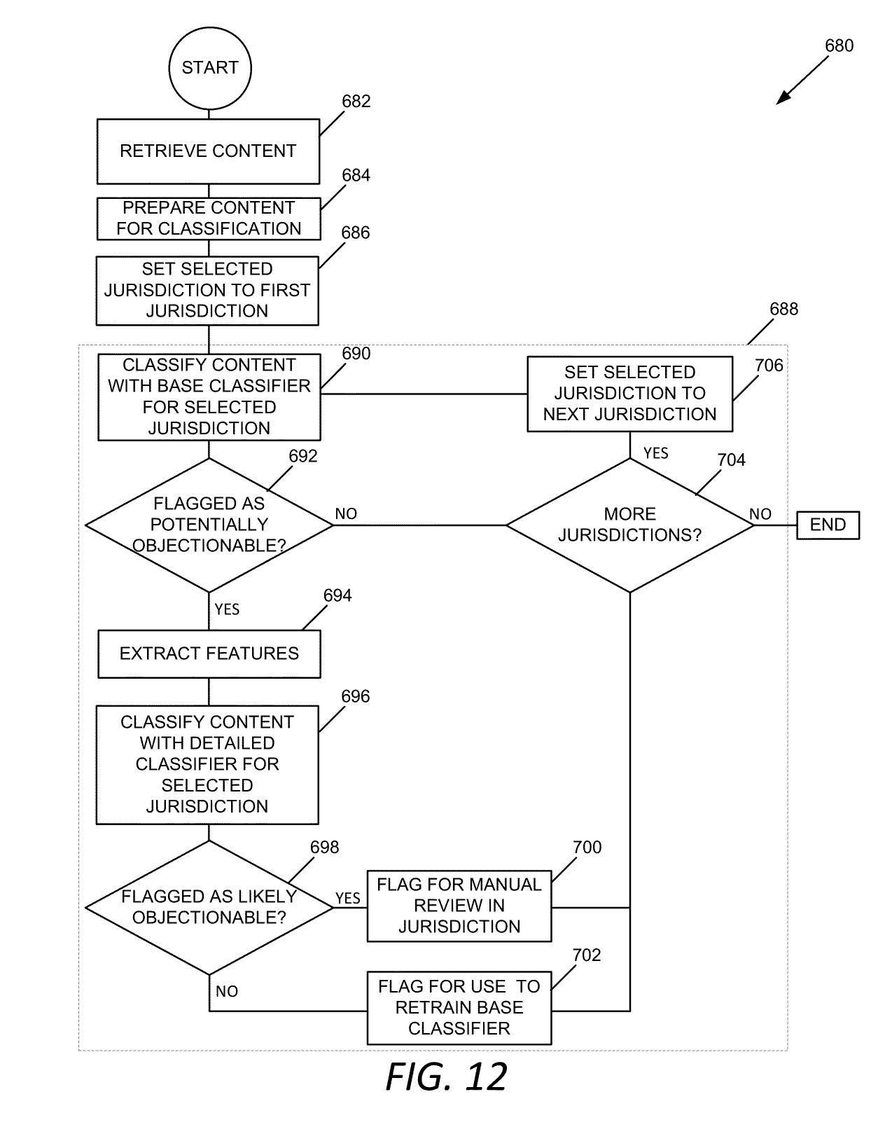

FIG. 12 illustrates an exemplary method 680 of classifying content performed by some embodiments of the system 100. In this example, the method 680 includes operations 682, 684, and 686 as well as loop 688. The loop 688 includes operations 690, 692, 694, 696, 698, 700, 702, 704, and 706. In some embodiments, the method includes operations that are performed by a processor (such as the processing device 220, shown in FIG. 2). The method 680 operates to classify the content in one or more jurisdictions. If the content is being performed in multiple jurisdictions, the operations in loop 688 will be performed multiple times.

At operation 682, the content that will be classified is retrieved. The content may be retrieved in various manners. For example, the content may be read from memory, loaded from a database, read from a local file system, or received over a network. Other embodiments are possible as well.

At operation 684, the content is prepared for classification. Preparing the content for classification may involve performing basic transformations on textual content (e.g., optical character recognition, uppercase to lowercase or vice versa, normalizing spelling, removing formatting or punctuation, etc.), stopword removal, and stemming. Some embodiments may perform additional steps to prepare the content for classification.

At operation 686, the selected jurisdiction is set to the first jurisdiction. Then, the operations of the loop 688 are performed on the selected jurisdiction.

At operation 690, the content is classified with a base classifier for the selected jurisdiction. The content can be classified using the base classification techniques described above or other classification techniques. For example, the content can be classified using the serialized Bayesian model 638 trained for the selected jurisdiction.

At operation 692, it is determined whether the content was classified as objectionable by the base classifier. If so, the content may be considered potentially objectionable in the selected jurisdiction and the method proceeds to operation 694. If not, the method proceeds to operation 704.

At operation 694, features are extracted from the content. The features may be extracted using natural language processing techniques. In at least some embodiments, features that are extracted during the first iteration of the loop 688 are stored in memory or elsewhere and are not re-extracted during later iterations of the loop 688. This operation 694 may be processing intensive, so it is only performed on the content that the base classifier classifies as objectionable.

At operation 696, the content is classified with a detailed classifier for the selected jurisdiction. The content can be classified using the detailed classification techniques described above or other classification techniques. For example, the content can be classified using the serialized detailed classifier model 660 trained for the selected jurisdiction.

At operation 698, it is determined whether the content was classified as objectionable by the detailed classifier. If so, the content may be considered likely objectionable in the selected jurisdiction and the method proceeds to operation 700. If not, the method proceeds to operation 702.

At operation 700, the content is flagged for manual review. For example, a record relating to the content may be added to a manual review job queue. The manual review job queue may be implemented as a table in the database 106. Alternatively, the content or data relating to the content may be stored in a particular file location or transmitted over the network 110 to the review station 108. Other embodiments are possible as well. The method then proceeds to operation 704.

At operation 702, the content is flagged for use in retraining the base classifier. In this situation, the base classifier reached a different classification result than the detailed classifier. In some embodiments, it is assumed that the base classifier reached an incorrect classification result. The base classifier can then be retrained using the flagged content as a new training example. In this manner, the performance of the base classifier can be improved over time as the system 100 is used to classify content. Additionally, some embodiments include a similar process to retrain the detailed classifiers when the detailed classifiers classify content as objectionable that is later determined to not be objectionable by manual review. The content may be flagged for use in retraining using methods similar to those used to flag content for manual review (e.g., adding a record to a database table, storing the content in a file location, sending the content to a computing device on the network, etc.). Other embodiments are possible as well however.

At operation 704, it is determined whether the content should be evaluated in more jurisdictions. If so, the method proceeds to operation 706 where the selected jurisdiction is set to the next jurisdiction and then the loop 688 is repeated.

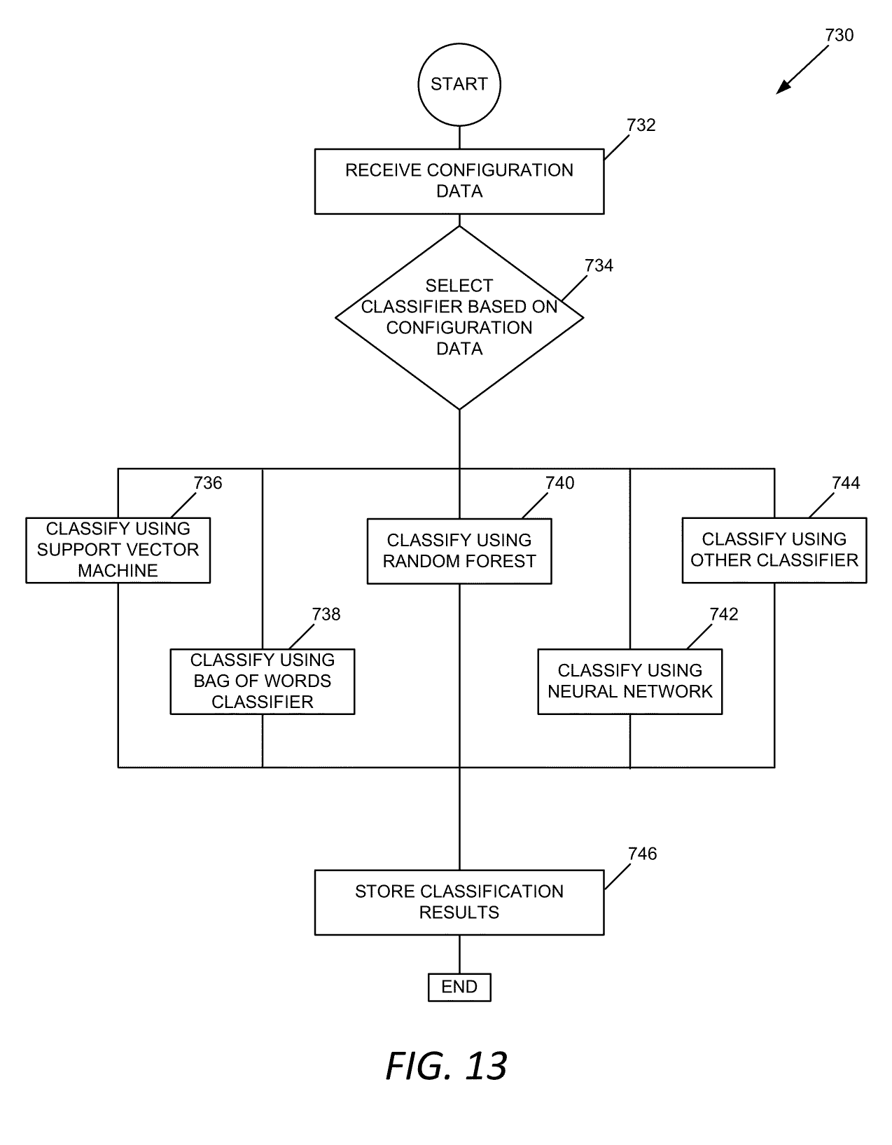

FIG. 13 illustrates an exemplary method of selecting a detailed classifier and classifying content using the selected detailed classifier performed by some embodiments of the system 100. In this example, the method 730 includes operations 732, 734, 736, 738, 740, 742, 744, and 746. In some embodiments, the method includes operations that are performed by a processor (such as the processing device 220, shown in FIG. 2).

At operation 732, configuration data is received. The configuration data may be retrieved from the database 106, a parameters file, or elsewhere. The configuration data may include parameters for selecting a classifier as well as parameters that are used by the classifiers.

At operation 734, a classifier is selected based on the configuration data. In some embodiments, the classifier may be selected based on other parameters as well. For example, the classifiers may be selected based on certain properties of the content itself such as the length of the content or the presence or absence of particular terms. Depending on which classifier is selected, the method will proceed to at least one of operations 736, 738, 740, 742, or 744. At operation 736, the content is classified using a support vector machine. At operation 738, the content is classified using a bag of words classifier. At operation 740, the content is classified using a random forest. At operation 742, the content is classified using a neural network. At operation 744, the content is classified using a different type of classifier. After the content is classified, the method proceeds to operation 746, where the results of the classification are stored.

In some embodiments of operation 734, only a single classifier is selected. Alternatively, more than one classifier can be selected. The results of the multiple classifiers can then be optionally weighted and combined to classify the content.

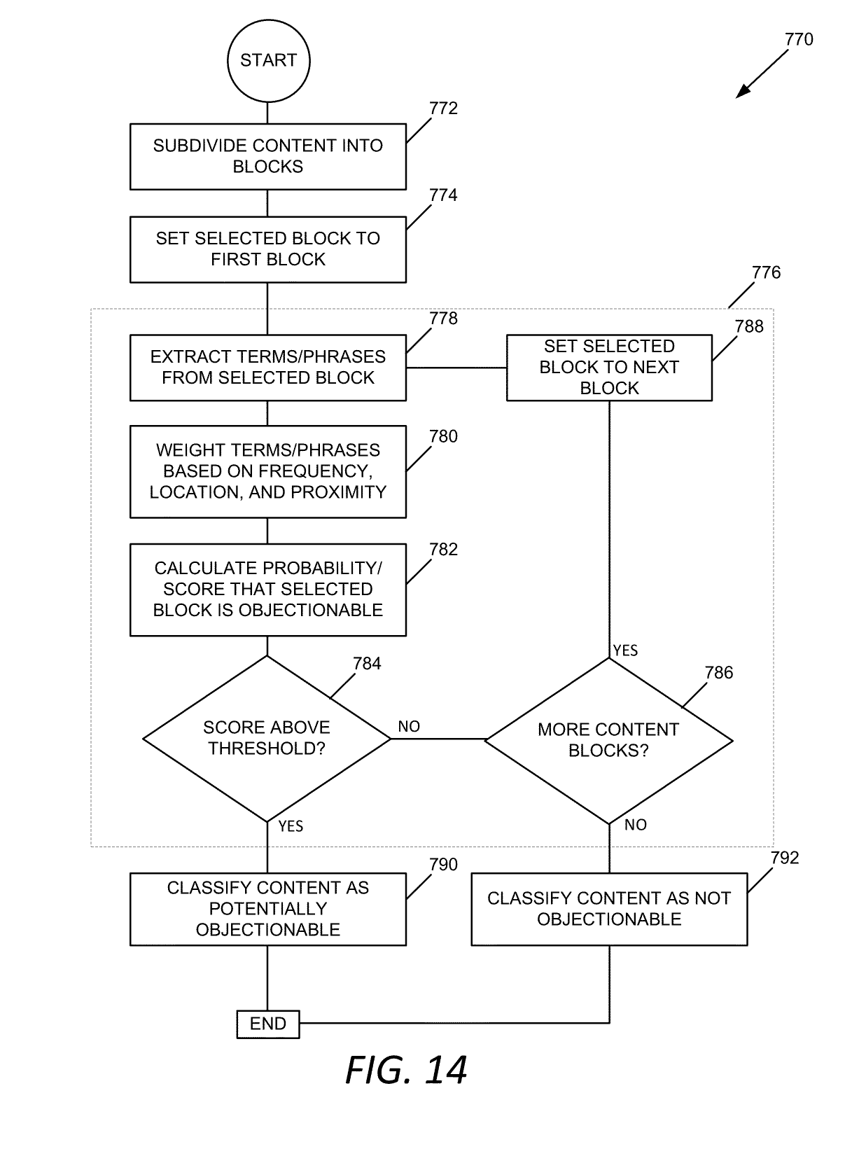

FIG. 14 illustrates an exemplary method 770 of classifying content performed by some embodiments of the system 100. In this example, the method 770 includes operations 772, 774, 790, and 792 as well as loop 776. The loop 776 includes operations 778, 780, 782, 784, 786, and 788. In some embodiments, the method includes operations that are performed by a processor (such as the processing device 220, shown in FIG. 2). The method 770 operates to classify the content by dividing the content into blocks and classifying each individual block. The loop 776 may be performed on each of the blocks. This process may be performed by the base classifier. A similar process may be performed by the detailed classifier.

At operation 772, the content is subdivided into blocks. The blocks may be associated with a paragraph, a page, or a particular number of words. Additionally, some content may be treated as a single block, while other content may divided into many blocks.

At operation 774, the selected block is set to the first block. Then a first iteration of the loop 776 is performed on the selected block.

At operation 778, terms or phrases are extracted from the selected block. The terms or phrases may correspond to single words or groups of words. In some embodiments, the terms and phrases that are extracted are based on a dictionary of terms and phrases, which are searched for within the content.

At operation 780, the terms and phrases are weighted. The terms and phrases may be weighted based on one or more of the frequency (or number of occurrences) of the terms and phrases, the location of the terms and phrases within the selected block, or the proximity of the terms and phrases to other terms and phrases with the selected block. Additionally, the weighting values may be based on the base classifier (e.g., the serialized Bayesian model 638).

At operation 782, a probability or score is calculated that the content of the selected block is objectionable. The score may be calculated by summing the weighted values for the terms and phrases from operation 780. Alternatively, the weighted values for the terms and phrases may be combined by averaging or by another method.

At operation 784, the score or probability value calculated in operation 782 is compared to a threshold value. If the score or probability value is greater than the threshold, the method proceeds to operation 790. If not, the method proceeds to operation 786. Because the content may not be reviewed in detailed or classified further if the base classifier classifies the content as not objectionable, the threshold may be set to a lower value that is intentionally over-inclusive. Beneficially, this lower threshold minimizes the chance that objectionable content will get past the base classifier. The primary cost associated with lower threshold is that more content blocks will need to be classified by the detailed classifiers than would be necessary with a higher threshold.

At operation 786, it is determined whether there are additional content blocks to classify. If so, the method proceeds to operation 788. At operation 788, the selected block is set to the next block and then a new iteration of the loop 776 begins on the newly-set selected block at operation 778. If there are not any additional content blocks, the method proceeds to operation 792, where the content is classified as not objectionable.

At operation 790, the content as a whole is classified as objectionable by the base classifier. The content may be considered potentially objectionable based on this classification by the base classifier. In some embodiments, the method 770 ends as soon as a single block is classified as objectionable by the base classifier. By stopping after a single block is classified as objectionable, the method 770 avoid unnecessary processing of the other blocks.

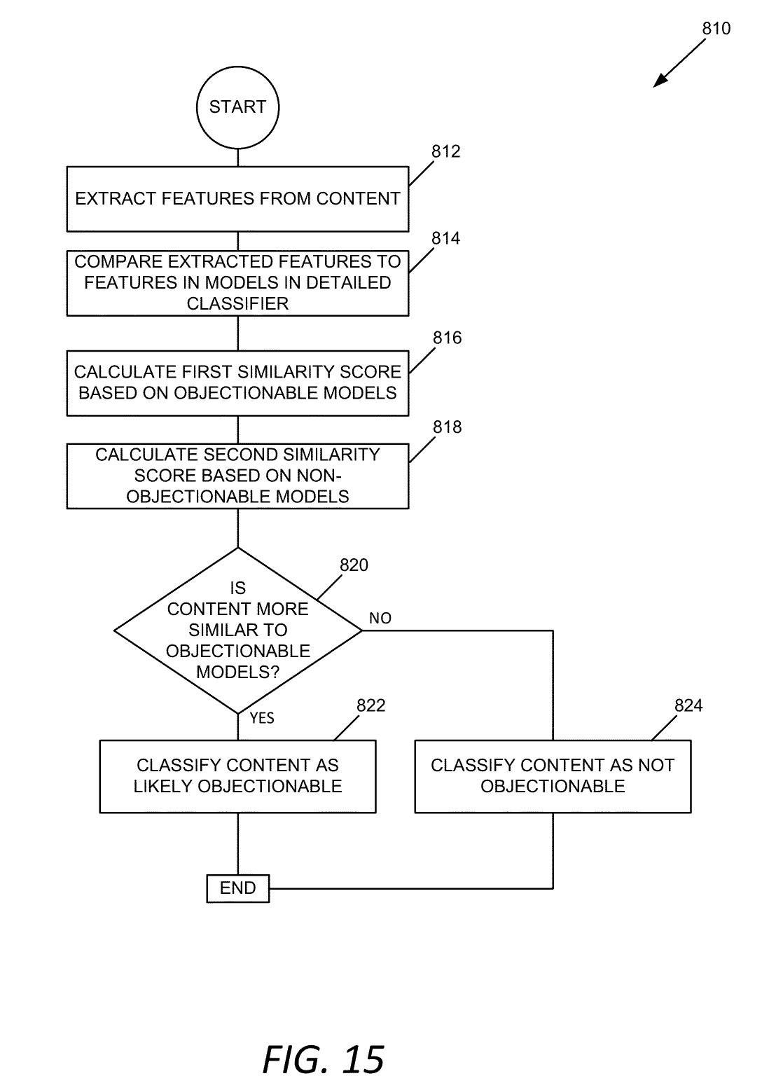

FIG. 15 illustrates an exemplary method 810 of classifying content using a detailed classifier performed by some embodiments of the system 100. In this example, the method 810 includes operations 812, 814, 816, 818, 820, and 822. In some embodiments, the method includes operations that are performed by a processor (such as the processing device 220, shown in FIG. 2).

At operation 812, features are extracted from the content. As described previously, the features can include topics or subjects to which the content is related and can be extracted using natural language processing techniques or other techniques. The features may be assigned scores that correspond to how relevant a particular feature is to the content.

At operation 814, the features that were extracted in operation 812 are compared to the models (e.g., sets of features extracted from the example content in the training corpuses) in the detailed classifiers. In some embodiments, the extracted features are compared to all of the models in the detailed classifier. In other embodiments, the extracted features are compared to only a portion of the models in the detailed classifier.

At operation 816, a first similarity score is calculated based on the similarity between the features extracted from the content and some or all of the objectionable models in the detailed classifier. Similarly, at operation 818, a second similarity score is calculated based on the similarity between the features extracted from the content and some or all of the non-objectionable models in the detailed classifier.

At operation 818, it is determined whether the content is more similar to the objectionable models or the non-objectionable models based at least in part on the first similarity score and the second similarity score. If the content is more similar to the objectionable models, the method proceeds to operation 822. If instead, the content is more similar to the non-objectionable models, the method proceeds to operation 824, where the content is classified as not objectionable.

At operation 822, the detailed classifier classifies the content as objectionable. The content may be considered likely objectionable based on the detailed classifier classifying it as objectionable.

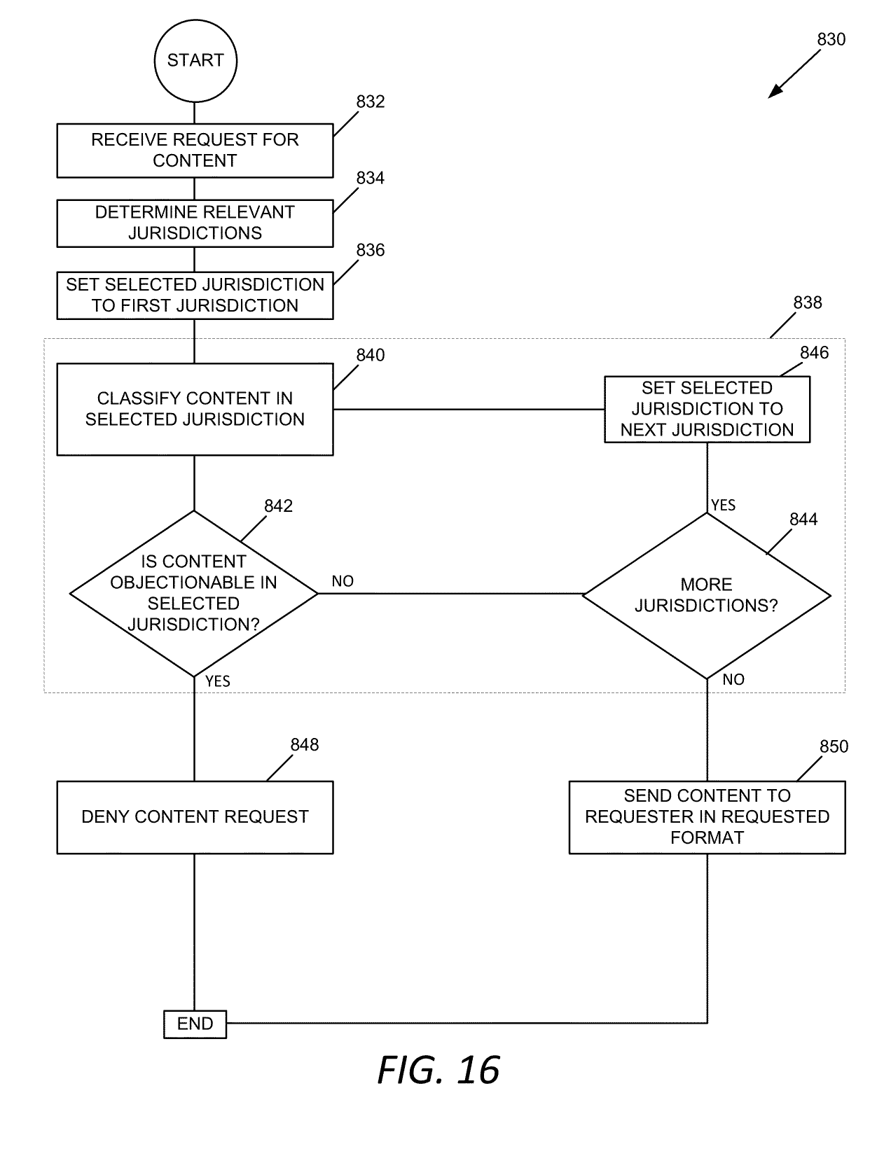

FIG. 16 illustrates an exemplary method 830 of processing a request for content performed by some embodiments of the system 100. In this example, the method 830 includes operations 832, 834, 836, 848, and 850. The method 830 also includes the loop 838, which includes operations 840, 842, 844, and 846. In some embodiments, the method includes operations that are performed by a processor (such as the processing device 220, shown in FIG. 2). The method 830 operates to classify content in one or more jurisdictions that are relevant to a particular request for content.

At operation 832, a request for content is received. The request may be received electronically via the network 122. At operation 834, the jurisdictions that are relevant to the request are determined. The relevant jurisdictions may be based on the geographic location of the requester (person or computing device), the citizenship of the person making the request, both, or other factors. In some instances, only a single jurisdiction is identified as relevant to the request. Alternatively, multiple jurisdictions may be identified as relevant (e.g., when the requester is subject to multiple standards regarding objectionable content such as when a state or province and a country impose by different standards).

At operation 836, the selected jurisdiction is set to the first jurisdiction. Then, the first iteration of the loop 838 is performed on the selected jurisdiction.

At operation 840, the content is classified in the selected jurisdiction. Classifying the content in the selected jurisdiction may involve classifying the content using one or more of a base classifier, a detailed classifier, and manual classification. Alternatively, if the content has already been classified in the selected jurisdiction and the result of the classification has been stored, the result is retrieved instead of reperforming the classification.

At operation 842, it is determined whether the content is objectionable in the selected jurisdiction. If the content is objectionable in the selected jurisdiction, the method proceeds to operation 848, where the request for the content is denied. If instead the content is not objectionable in the selected jurisdiction, the method proceeds to operation 844.

At operation 844, it is determined whether there are more jurisdictions to evaluate. If there are more jurisdictions to evaluate, the method proceeds to operation 846. If there are not any more jurisdictions to evaluate, the method proceeds to operation 850.

At operation 846, the selected jurisdiction is set to the next jurisdiction. Then, the loop 838 is repeated on the newly-set selected jurisdiction. In this manner, the method 830 evaluates the content in all of the jurisdictions relevant to the request.

At operation 850, the content is sent to the request in the requested format. In some embodiments, the content is sent electronically (e.g., as an eBook). In other embodiments, the content may be sent physically as a printed book such as a book printed by the printer 118.

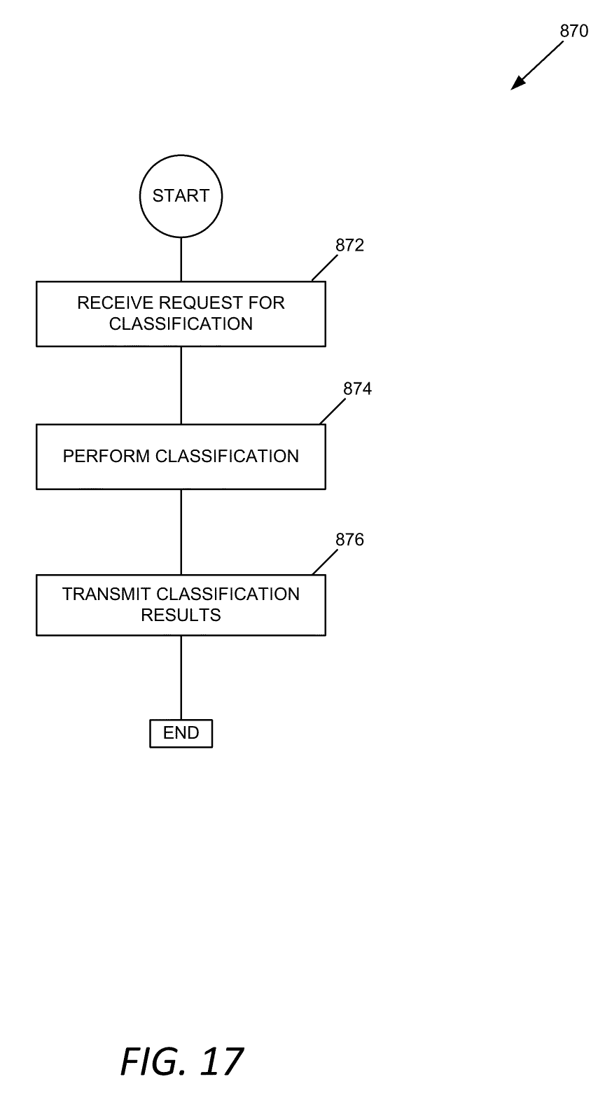

FIG. 17 illustrates an exemplary method 870 of classifying submitted content performed by some embodiments of the system 100. In this example, the method 870 includes operations 872, 874, and 876. In some embodiments, the method includes operations that are performed by a processor (such as the processing device 220, shown in FIG. 2).

At operation 872, a request for classification is received. The requested may be transmitted via the network 122 and may be received through a web interface or a different interface. In some embodiments, the request includes the content as an embedded variable such as a base64 embedded string. In other embodiments, the request may include a URI that identifies a location where the content may be accessed. The request may identify a relevant jurisdiction or include a list of relevant jurisdictions. Additionally, in some embodiments, the request may specify that some or all of the features extracted from the content be returned. The request may also include a job identifier or other information that is useful for workflow management.

At operation 874, the classification is performed in accordance with the request. At operation 876, the classification results are transmitted to the requester. In some embodiments, a simple classification complete message is transmitted to the requester when the content is not classified as objectionable. If the content is classified as objectionable, the response may include a list or the jurisdictions in which the content was classified as objectionable. Additionally, the response may include some or all of the features extracted that are related to the classification of the content as objectionable.

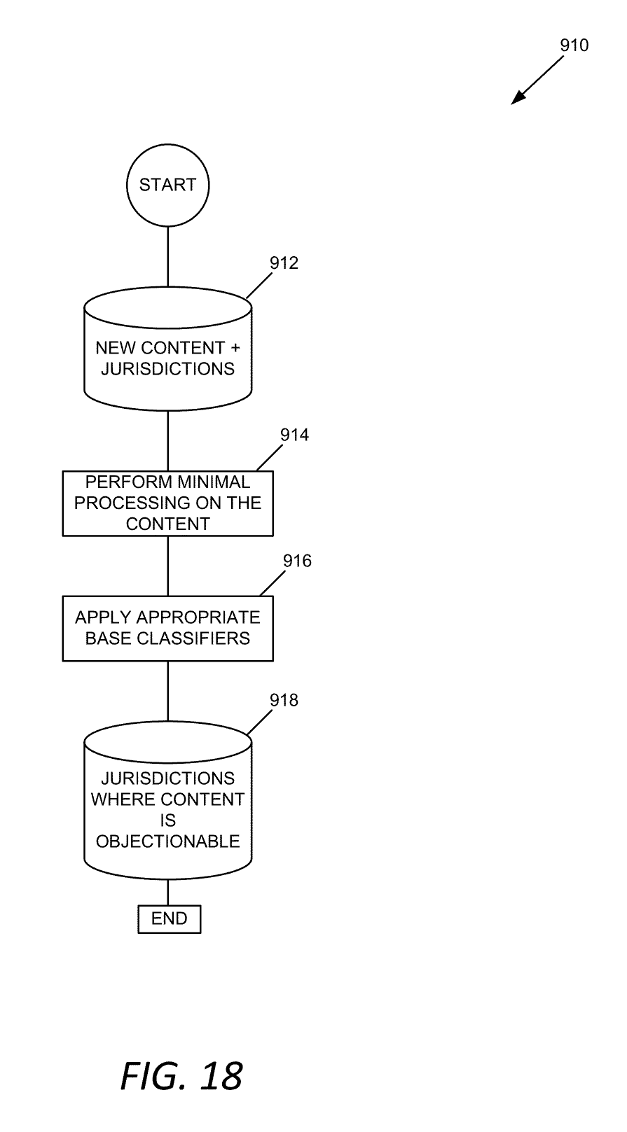

FIG. 18 illustrates an exemplary method 910 of classifying new content for multiple jurisdictions performed by some embodiments of the system 100. In this example, the method 910 receives data 912 representing new content and relevant jurisdictions and classifies the new content to generate data 918 representing jurisdictions where the content is objectionable. The method 910 includes operations 914 and 916. In some embodiments, the method includes operations that are performed by a processor (such as the processing device 220, shown in FIG. 2).

At operation 914, minimal processing is performed on the content. For example, stop words may be removed and stemming may performed. In other embodiments, additional or different steps are performed on the content. Beneficially, in at least some embodiments, the minimal processing does not require significant computation resources and can be completed quickly.

At operation 916, the appropriate base classifiers are application to the content. The appropriate base classifiers may be identified based on the jurisdictions listed in the data 912. Alternatively, all base classifiers available may be applied to the content. In at least some embodiments, the base classifiers are not computationally intensive (at least relative to the detailed classifiers). For example, classifying with the base classifiers may use 1% of the computational resources required to perform classification using the detailed classifiers.

The results of operation 916 is data 918 representing a list of jurisdictions where the content has been classified as objectionable. If the content is classified as objectionable in any of the jurisdictions, it may be flagged for evaluation using the detailed classifiers for all of the jurisdictions. In some embodiments, the base classifiers are configured so that approximately 1% of the content processed is identified as objectionable in any jurisdictions.

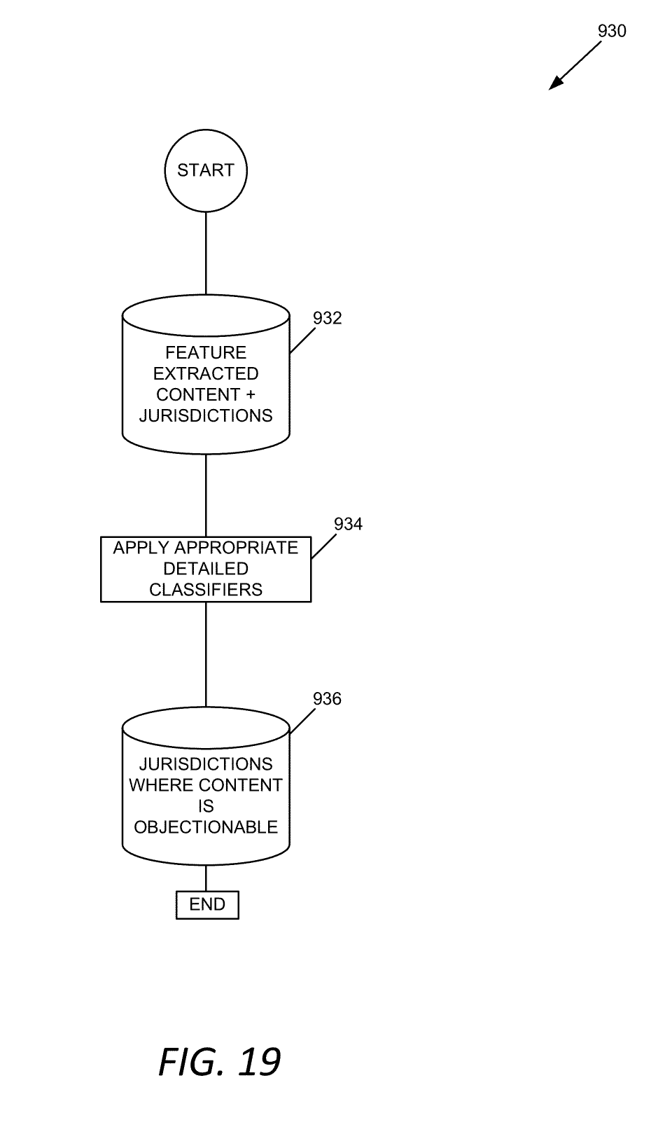

FIG. 19 illustrates an exemplary method 930 of classifying content using detailed classifiers for multiple jurisdictions performed by some embodiments of the system 100. In this example, the method 930 receives data 932 representing content with features extracted and relevant jurisdictions and classifies the new content to generate data 936 representing jurisdictions where the content is objectionable. The method 910 includes operation 934. In some embodiments, the method includes operations that are performed by a processor (such as the processing device 220, shown in FIG. 2).

At operation 934, the appropriate detailed classifiers are applied to the content and the features extracted from the content. The detailed classifiers provide classification based upon the extracted feature vector space.

The results of operation 934 is data 963 representing a list of jurisdictions in which the content has been classified by detailed classifiers as objectionable. Based upon this classification, metadata associated with the content may be marked as objectionable and the content may be unavailable until is reviewed by human reviewer. However, in some embodiments, the content may not be reviewed manually.

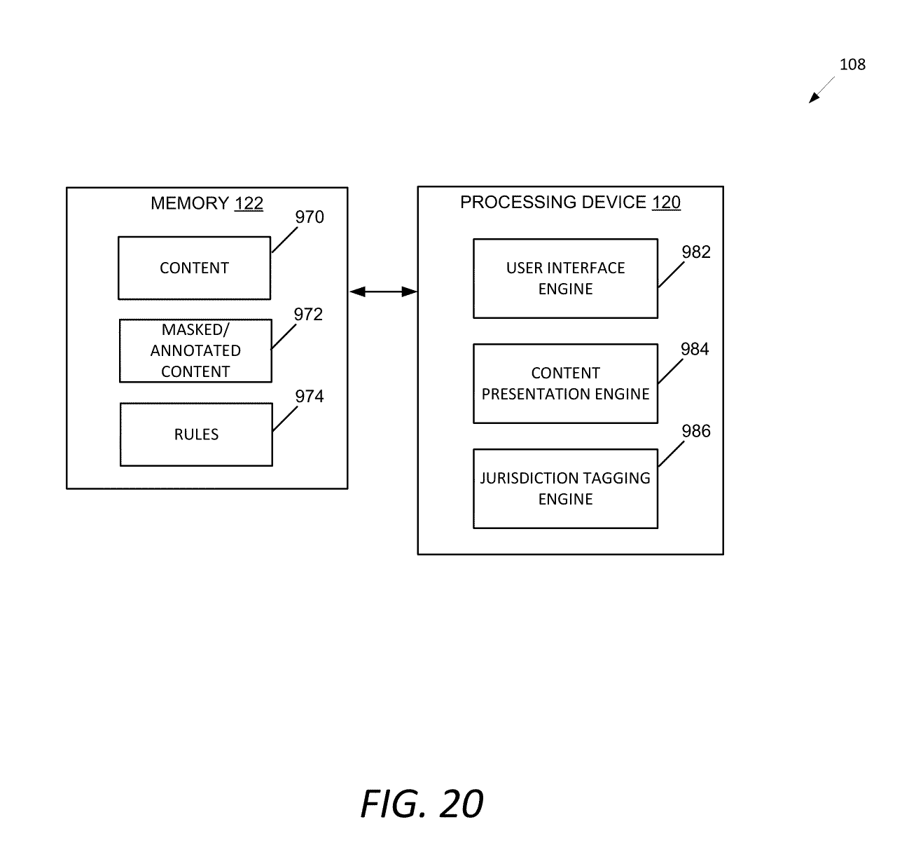

FIG. 20 illustrates an exemplary architecture of the processing device 220 and the program data 242 of the review station 108. The processing device 220 is configured to execute a plurality of engines. The engines include a user interface engine 982, a content presentation engine 984, and a jurisdiction tagging engine 986.

Program data 242 is stored in a data storage device, such as the memory 222 or the secondary storage device 232 (shown in FIG. 2). In some embodiments, program data 242 includes content 970, masked/annotated content 972, and rules 974. The content 970 may include content that needs to be presented to a human operator for manual review (e.g., content that has been classified by the detailed classifiers as objectionable). The masked/annotated content 972 may include content that has been masked to obscure the portions of the content that are identified as obscene as well as annotated to identify the portions of the content that have been flagged for review by a human operator. The rules 974 may include textual descriptions of the rules regarding the standards for objectionable content in particular jurisdictions.

In an exemplary embodiment, the data stored in program data 242 can be represented in one or more files having any format usable by a computer. Examples include text files formatted according to a markup language and having data items and tags to instruct computer programs and processes how to use and present the data item. Examples of such formats include html, xml, and xhtml, although other formats for text files can be used. Additionally, the data can be represented using formats other than those conforming to a markup language.

The user interface engine 982 operates to generate user interfaces on the review station 108. For example, the user interface engine 982 may operate to generate a user interface for a human operator to review content and tag that content as objectionable or not objectionable.

The content presentation engine 984 operates to display the content 970 or the masked/annotated content 972. The jurisdiction tagging engine 986 operates to tag content as objectionable or not objectionable based on the review by the operator.

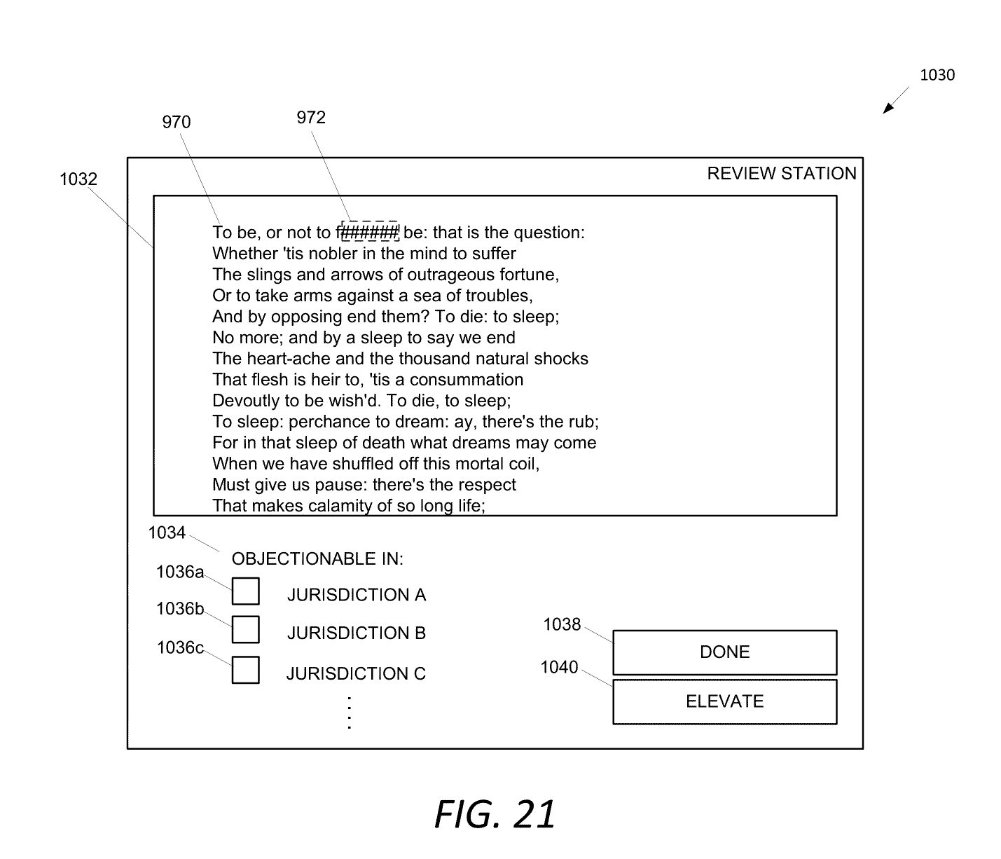

FIG. 21 illustrates an exemplary user interface 1030 of the review station 108. The user interface includes a content display panel 1032, a jurisdiction list 1034, a done button 138, and an elevate button 1040. In at least some embodiments, the user interface 1030 includes different or additional user interface elements as well.

The content display panel 1032 operates to display the content 970 so that a human operator can review it. In the example shown, the content display panel 1032 is interspersing the masked/annotated content 972 with the content 970. Beneficially, this obscures the portion of the content 970 that is potentially objectionable. Although shown in this example as a single word, a larger portion of the content 970 may be obscured in other examples. In some embodiments, the content display panel 1032 removes the masked/annotated content 972 if the operator hovers over the masked/annotated content 972. In this manner, the operator can fully evaluate the content 970. On other embodiments, the user interface 1030 includes other user interface controls (e.g., buttons) to remove the masked content and cause more of the content that has been classified as objectionable to be displayed. However, it is expected that it will often be unnecessary for the operator to view the unmasked content to determine whether it is objectionable.

The jurisdiction list 1034 operates to list the jurisdiction in which the content 970 is being reviewed. In this example, the jurisdiction list 1034 includes checkboxes 1036a, 1036b, and 1036c that are operable to indicate that the content is objectionable in the associated jurisdiction. In some embodiments, the jurisdiction list 1034 may also include at least one of an “All of the Above” checkbox and a “None of the Above” checkbox.

The done button 1038 operates to indicate the review is complete and that the operator has clicked on all of the appropriate checkboxes in the jurisdiction list 1034. The elevate button 1040 operates to flag the content 970 for further review by another operator such as a supervisor.

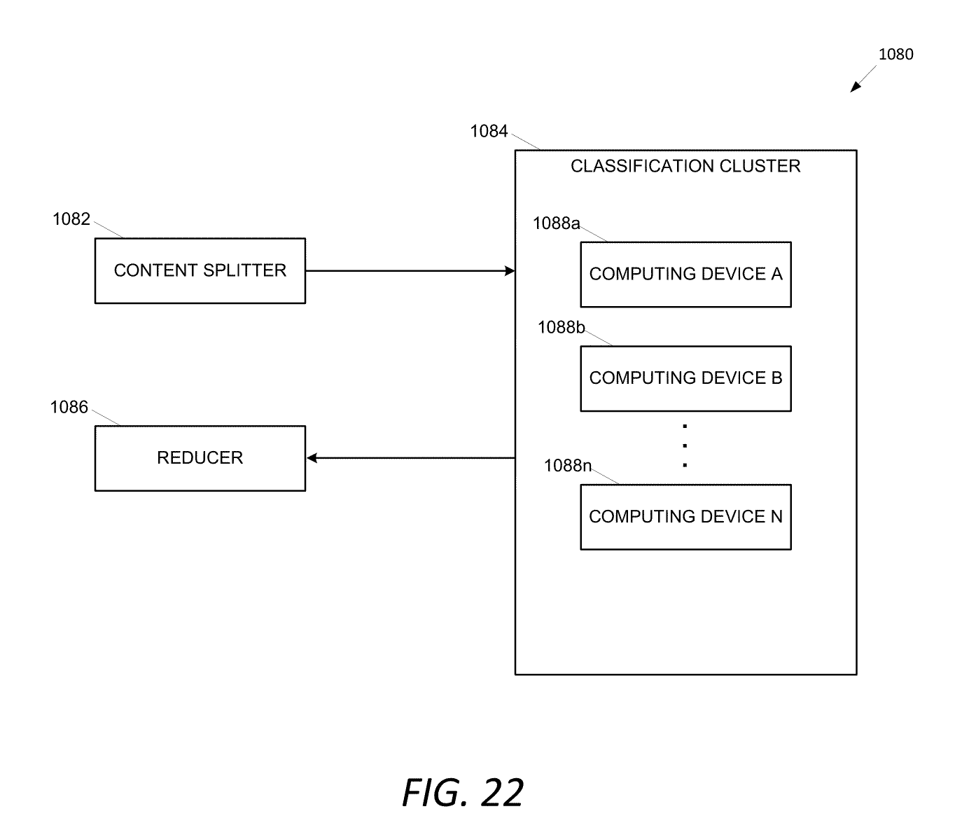

FIG. 22 illustrates an exemplary architecture of the system 100 for performing classification in parallel using a server farm 1080. The server farm 1080 is an example of the server 104. The server farm 1080 includes a content splitter 1082, a classification cluster 1084, and a reducer 1086. The classification cluster 1084 includes a plurality of computing devices. In this example, computing devices 1088a, 1088b, and 1088n of the classification cluster 1084 are illustrated. However, the classification cluster can include any number of computing devices.

The content splitter 1082 is a computing device that operates to split content into blocks and distributes the blocks to the computing devices of the classification cluster 1084.

The computing devices of the classification cluster 1084 operate to classify blocks of content. The computing devices may perform all of the steps described previously related to classifying content using base classifiers and detailed classifiers. In some embodiments, the computing devices of the classification cluster 1084 transmit the results of the classification to the reducer 1086.

The reducer 1086 is a computing device that operates to receive the results of the classification performed by the computing devices of the classification cluster 1084 and combine the results into a cumulative result for the content. In at least some embodiments, the cumulative result for the content is set to the objectionable if any of the blocks of content are classified as objectionable by the computing devices of the classification cluster.

Beneficially, the classification of content may be completed more quickly if it is performed in parallel as illustrated in FIG. 22. This speed can be useful in embodiments that operate to respond to requests for classification on-demand. Although FIG. 22 illustrates parallel processing of classification using a server farm containing many computing devices, other embodiments operate similarly using a single computing device using multiple processors (e.g., using multithreading). Additionally, in some embodiments the content splitter 1082 and the reducer 1086 are the same computing device.

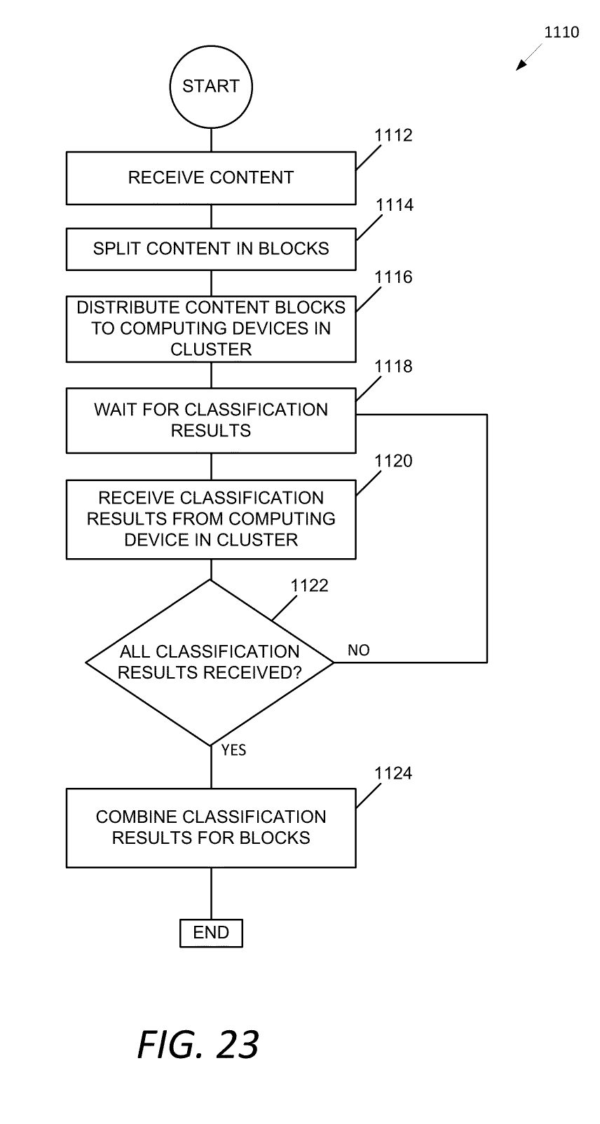

FIG. 23 illustrates an exemplary method 1110 of performing classification in parallel performed by some embodiments of the system 100. In this example, the method 1110 includes operations 1112, 1114, 1116, 1118, 1120, 1122, and 1124. In some embodiments, the method includes operations that are performed by a processor (such as the processing device 220, shown in FIG. 2). The method 1110 may be performed in combination by one or more computing devices, such as the content splitter 1082 and the reducer 1086.

At operation 1112, the content is received. At operation 1114, the content is split in blocks. The content may be split into blocks based on a predefined number of characters, words, sentences, paragraphs, pages, or chapters. In other embodiments, the content is split based on other criteria however.

At operation 1116, the content blocks are distributed to the computing devices in a classification cluster such as classification cluster 1084. The content blocks may be transmitted individually to each of the computing devices. Alternatively, the content blocks may be stored on a file system that can be accessed by the computing devices.

At operation 1118, classification results are waited for. At operation 1120, a classification result is received from one of the computing devices in the classification cluster. At operation 1122, it is determined whether all of the results have been received. If so, the method proceeds to operation 1124, where the classification results for the content blocks are combined into a cumulative results. If not, the method returns to operation 1118 to continue waiting for more classification results.

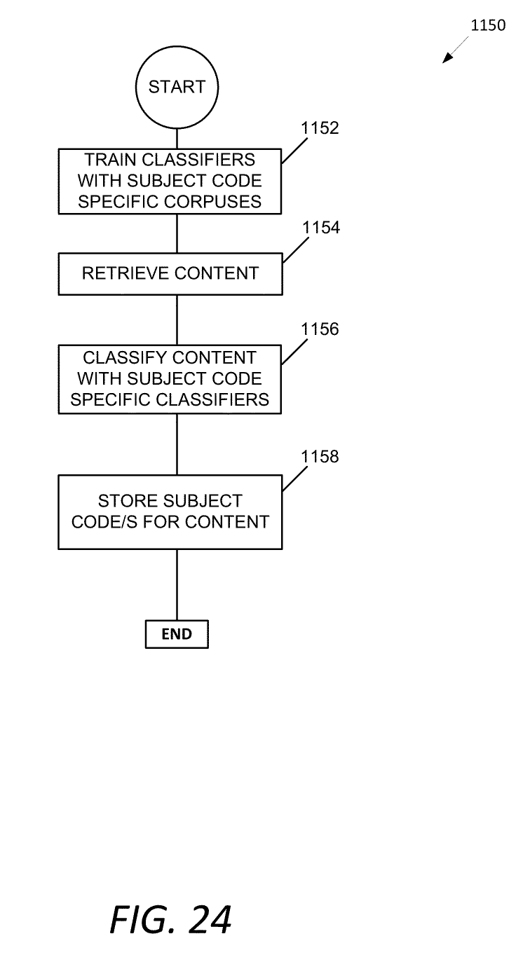

FIG. 24 illustrates an exemplary method 1150 of performing classification by subject code performed by some embodiments of the system 100. In this example, the method 1150 includes operations 1152, 1154, 1156, and 1158. In some embodiments, the method includes operations that are performed by a processor (such as the processing device 220, shown in FIG. 2).

At operation 1152, classifiers are trained using subject code-specific corpuses. At operation 1154, the content is retrieved. At operation 1156, the content is classified using the subject code-specific classifiers. At operation 1158, the subject codes for the content are stored.

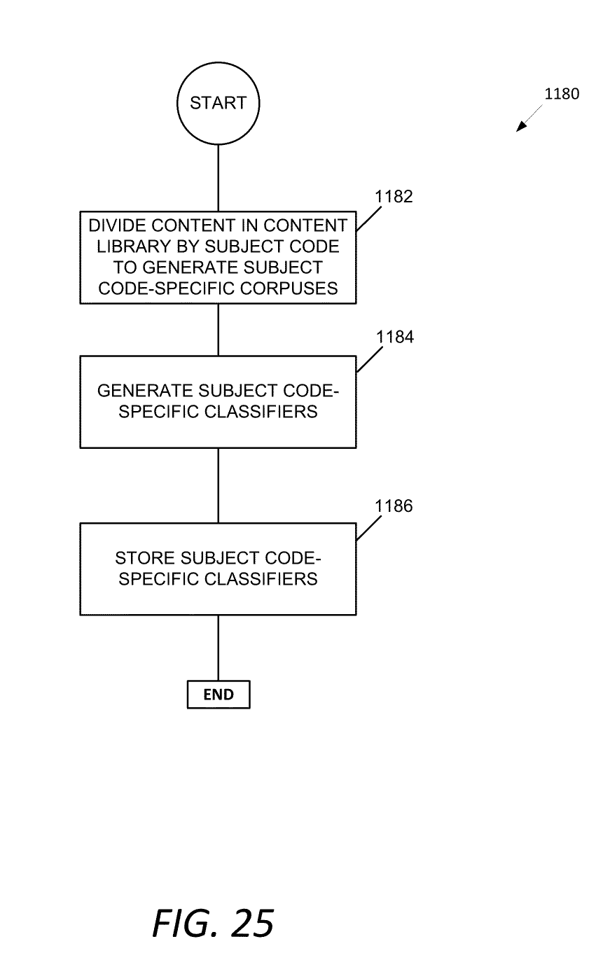

FIG. 25 illustrates an exemplary method 1180 of generating subject code-specific classifiers performed by some embodiments of the system 100. In this example, the method 1180 includes operations 1182, 1184, and 1186. In some embodiments, the method includes operations that are performed by a processor (such as the processing device 220, shown in FIG. 2).

At operation 1182, the content is the content library is divided by subject code to generate subject code-specific corpuses. Often content is manually assigned one or more subject codes by the content publisher or another entity. Accordingly, the content library will typically include many content examples that are pre-tagged with subject codes.

At operation 1184, subject code-specific classifiers are generated based on the subject code-specific classifiers. The subject code-specific classifiers can be generated using any of the classifier training techniques described above in the context of classifying objectionable content. Additionally, the subject code-specific classifiers can be generate using other classifier training techniques as well. At operation 1186, the trained subject code-specific classifiers are stored for later use.

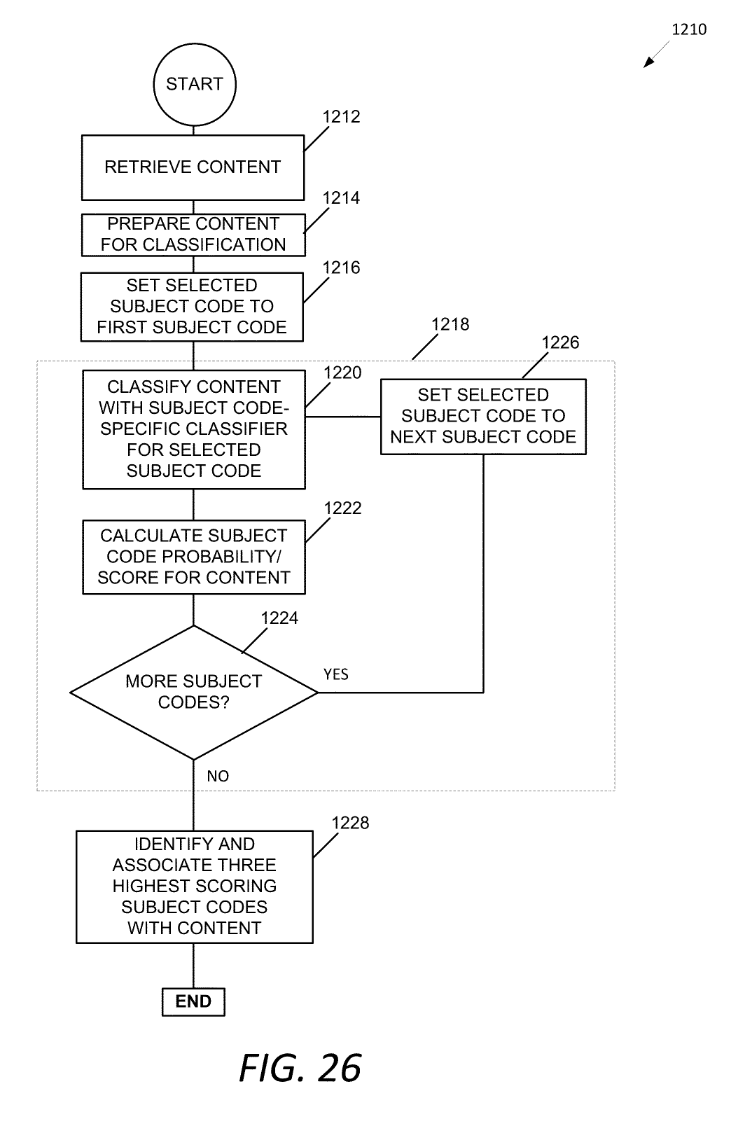

FIG. 26 illustrates an exemplary method 1210 of classifying content for multiple subject codes performed by some embodiments of the system 100. In this example, the method 1210 includes operations 1212, 1214, 1216, and 1228. The method 1210 also includes the loop 1218, which includes operations 1220, 1222, 1224, and 1226. In some embodiments, the method includes operations that are performed by a processor (such as the processing device 220, shown in FIG. 2). The method 1210 operates to classify content for multiple subject codes in a list of subject codes to identify subject codes that are appropriate for the content.

At operation 1212, the content is retrieved. At operation 1214, the content is prepared for classification. This operation may be similar to operation 684, described above. At operation 1216, the selected subject code is set to the first subject code. Then, the loop 1218 is performed on the selected subject code.

At operation 1220, the content is classified using the subjection code-specific classifier for the selected subject code. At operation 1222, a probability or score for the content is calculated based on the results of operation 1220. The probability or score corresponds to how likely it is that the selected subject code is related to the content.

At operation 1224, it is determined whether there are more subject codes for which the content needs to be classified against. If so, the method proceeds to operation 1226, where the selected subject code is set to the next subject code so that the loop 1218 can be performed on that subject code. If not, the method proceeds to operation 1228.

At operation 1228, the highest scoring subject codes are identified. In some embodiments, the three highest scoring subject codes are identified. However, in other embodiments, a different number of subject codes are identified.

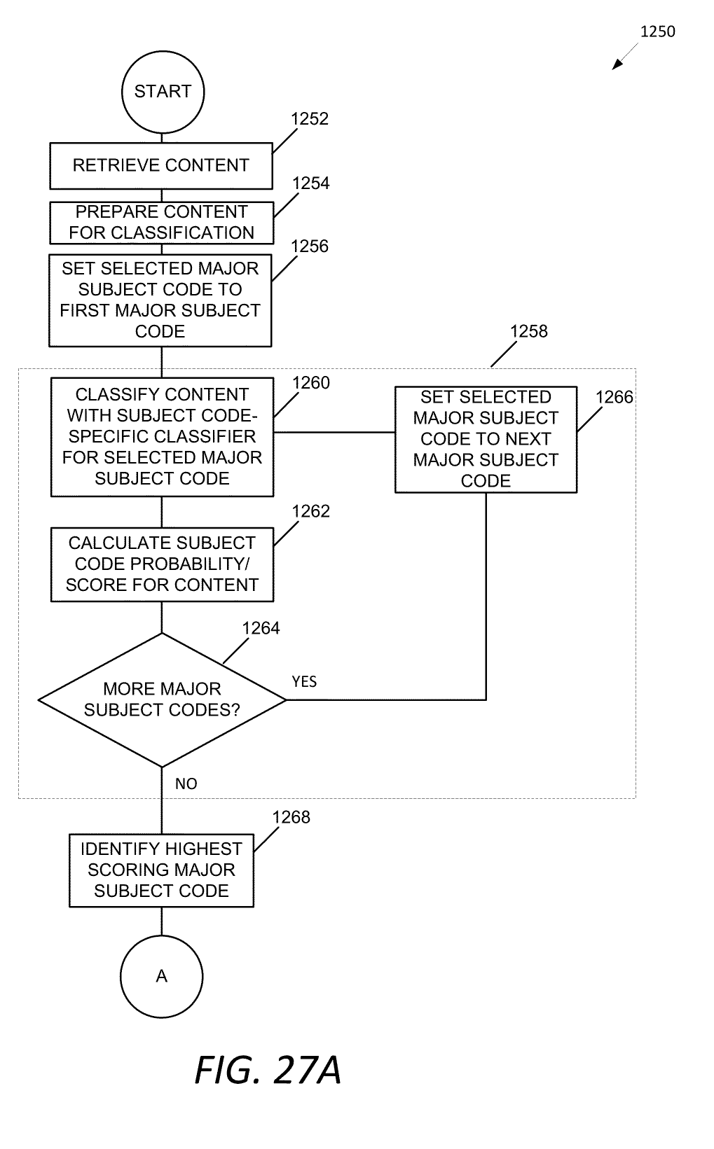

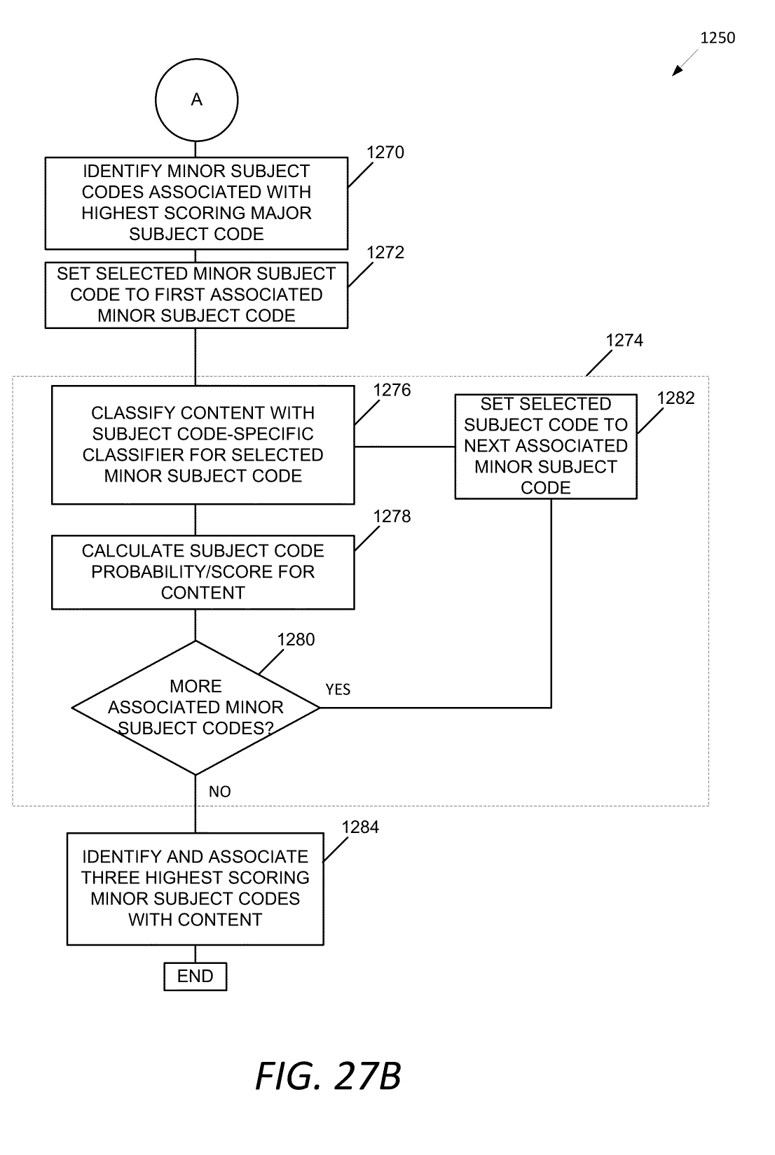

FIGS. 27A and 27B illustrate another exemplary method 1250 of classifying content for multiple subject codes performed by some embodiments of the system 100. In this example, the method 1250 includes operations 1252, 1254, 1256, 1268, 1270, 1272, and 1284. The method 1250 also includes the loops 1258 and 1274. The loop 1258 includes operations 1260, 1262, 1264, and 1266. The loop 1274 includes operations 1276, 1278, 1280, and 1282. In some embodiments, the method includes operations that are performed by a processor (such as the processing device 220, shown in FIG. 2).

The method 1250 operates to classify content for multiple subject codes when the subject codes are organized hierarchically such as with BISAC subject codes. The method 1250 is illustrated in the context of a two-level hierarchy. However, similar concepts can be applied to extend the method 1250 to additional layers in subject code hierarchy. In this example, the subject codes are organized into major subject codes and minor subject codes. Each major subject code may include multiple minor subject codes.

At operation 1252, the content is retrieved. At operation 1254, the content is prepared for classification. This operation may be similar to operation 684, described above. At operation 1256, the selected major subject code is set to the first major subject code. Then, the loop 1258 is performed on the selected major subject code.

At operation 1260, the content is classified using the subjection code-specific classifier for the selected major subject code. At operation 1262, a probability or score for the content is calculated based on the results of operation 1260. The probability or score corresponds to how likely it is that the selected major subject code is related to the content.

At operation 1254, it is determined whether there are more major subject codes for which the content needs to be classified against. If so, the method proceeds to operation 1266, where the selected major subject code is set to the next major subject code so that the loop 1258 can be performed on that major subject code. If not, the method proceeds to operation 1268.

At operation 1268, the highest scoring major subject code is identified. In this example, only a single major subject code is identified. Although, in other embodiments more than one major subject code may be identified.

At operation 1270, the minor subject codes associated with the major subject code (or major subject codes in some embodiments) are identified. At operation 1272, the selected minor subject code is set to the first minor subject code identified in operation 1270. Then, the loop 1274 is performed on the selected minor subject code.

At operation 1276, the content is classified using the subjection code-specific classifier for the selected minor subject code. At operation 1278, a probability or score for the content is calculated based on the results of operation 1276. The probability or score corresponds to how likely it is that the selected minor subject code is related to the content.

At operation 1280, it is determined whether there are more minor subject codes for which the content needs to be classified against. If so, the method proceeds to operation 1282, where the selected minor subject code is set to the next minor subject code so that the loop 1274 can be performed on that minor subject code. If not, the method proceeds to operation 1284.

At operation 1284, the highest scoring minor subject codes are identified. In some embodiments, the three highest scoring minor subject codes are identified. However, in other embodiments, a different number of minor subject codes are identified.

Although FIGS. 24-27 describe various exemplary methods in the context of classifying content into subject codes, in other embodiments the exemplary methods are used for other purposes as well such as classifying by reading level, literary style, author style, theme, language, and various other properties. Other embodiments are possible as well.

Additionally, the results of classifying content into subject codes or various other properties can be used to select a second classifier to apply to the content. For example, content that is classified as being at a youth or child reading level might be classified using a classifier trained on different objectionable content than content classified as being at an adult reading level. As another example, content classified with a religious subject code might trigger evaluation with another particular classifier in some Arabian caliphates (e.g., the content may then be classified using an objectionable content classifier trained to classify content as heresy in those jurisdictions). In some embodiments, additional subsequent classifiers may also be selected based on the results of the second classifiers forming chains of classifiers. These chains of classifiers can have any number of links.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of classifying textual content as objectionable, the method comprising:
analyzing a body of the content to determine a level of similarity between text in the content and a corpus of predetermined content;
upon determining that the level of similarity is greater than a predefined threshold:
using natural language processing to extract a plurality of features from the content, the features being associated with concepts related to the body of the content;
analyzing the extracted features to determine a second level of similarity between the content and the corpus of predetermined content; and
upon determining that the second level of similarity is greater than a second predefined threshold, classifying the content as objectionable.

2. The method of claim 1, wherein the body of the content is analyzed using a base classifier trained using the corpus of predetermined content.

3. The method of claim 1, wherein the extracted features are analyzed using a detailed classifier trained using features extracted from the corpus of predetermined content.

4. The method of claim 1, wherein the base classifier and the detailed classifier are retrieved from a database based upon determining a jurisdiction that is relevant to the content.

5. The method of claim 1, wherein the corpus of predetermined content contains a plurality of examples of objectionable content.

6. The method of claim 1, wherein the using natural language processing to extract the plurality of features is performed using technology selected from a group of natural language processing technologies comprising:
latent semantic analysis; and
latent Dirichlect allocation.

7. The method of claim 1, further comprising upon classifying the content as objectionable, flagging the content for review by a human operator.

8. The method of claim 1, wherein the content is objectionable if it contains obscenity.

9. The method of claim 1, wherein the content is objectionable if it contains hate speech.

10. The method of claim 1, wherein the content is objectionable if it contains political content.

11. A method of screening content for objectionable content, the method comprising:
receiving, by a computing device, the content;
determining a jurisdiction that is relevant to the content;
analyzing a body of the content to determine a level of similarity between text in the content and a corpus of predetermined content, the predetermined content being objectionable in the jurisdiction; and
upon determining the level of similarity is greater than a predefined threshold transmitting a message indicating that the content is objectionable in the jurisdiction.

12. The method of claim 11, wherein determining a jurisdiction that is relevant to the content comprises determining two or more jurisdictions.

13. The method of claim 12, wherein the predetermined content is objectionable in at least two of the determined two or more jurisdictions.

14. The method of claim 11, wherein determining the jurisdiction that is relevant to the content comprises receiving a jurisdiction list comprising one or more jurisdictions.

15. The method of claim 11, wherein determining the jurisdiction that is relevant to the content comprises selecting all active jurisdictions.

16. The method of claim 11, wherein determining at least one jurisdiction that is relevant to the content comprises identifying a geographic location associated with the content and identifying at least one jurisdiction associated with the geographic location.

17. The method of claim 11, wherein analyzing the body of the content to determine the level of similarity between text in the content and the corpus of predetermined content comprises classifying the content using at least one classifier trained using the predetermined content.

18. The method of claim 11, wherein the classifying the content comprises extracting features from the content.

19. The method of claim 11, further comprising the step of dividing the content into a plurality of content blocks.

20. The method of claim 11, further comprising encrypting the content and storing the encrypted content.

21. The method of claim 20, wherein the content is encrypted using an encryption technique selected from the group of encryption techniques comprising:
ROT-13;
PGP;
DES;
AES;
SHA;
IDEA; and
Blowfish.

22. A system comprising:
a data store encoded on a memory device, the data store comprising a base classifier and a detailed classifier, wherein the base classifier is trained using examples of objectionable content and examples of non-objectionable content, and wherein the detailed classifier is trained using features extracted from the examples of objectionable content and the examples of non-objectionable content; and
a computing device in data communication with the data store, the computing device programmed to:
analyze a body of content using the base classifier to determine a level of similarity between text in the content and the examples of objectionable content;
upon determining that the level of similarity is greater than a predefined threshold:
use natural language processing to extract a plurality of features from the content, the features being associated with concepts related to the body of the content;
analyze the extracted features using the detailed classifier to determine a second level of similarity between the content and the examples of objectionable content; and
upon determining that the second level of similarity is greater than a second predefined threshold, classify the content as objectionable.

23. The system of claim 22, wherein the computing device is further programmed to upon classifying the content as objectionable, flag the content for review by a human operator.

24. A method of identifying relevant subject codes for content, the method comprising:
analyzing a body of the content with a plurality of subject code-specific classifiers, wherein each of the subject code-specific classifiers of the plurality are associated with at least one subject code and are configured to determine a level of similarity between text in the content and pre-identified examples of content associated with the at least one subject code;
calculating a plurality of subject code scores for the content based on the subject code-specific classifiers; and
selecting at least one subject code as relevant based on the plurality of subject code scores.

25. The method of claim 24, wherein the selecting at least one subject code as relevant comprises selecting three subject codes as relevant.

26. The method of claim 25, further comprising:
upon selecting at least one subject code as relevant:
identifying minor subject codes associated with the selected at least one subject code;
analyzing the body of the content with a plurality of minor subject code-specific classifiers, wherein each of the minor subject code-specific classifiers of the plurality are associated with at least one minor subject code and are configured to determine a level of similarity between text in the content and examples of pre-identified examples of content associated with the at least one minor subject code;
calculating a plurality of minor subject code scores for the content based on the minor subject code-specific classifiers; and
selecting at least one minor subject code as relevant based on the plurality of minor subject code scores.

27. A method of identifying relevant attributes for a content, the method comprising:
analyzing a body of the content with a plurality of attribute-specific classifiers, wherein each of the attribute-specific classifiers of the plurality are associated with at least one attribute and are configured to determine a level of similarity between text in the content and pre-identified examples of content associated with the at least one attribute;
calculating a plurality of attribute scores for the content based on the attribute-specific classifiers; and
selecting at least one attribute as relevant based on the plurality of attribute scores.

28. The method of claim 27, wherein the method identifies relevant attributes of a type selected from a group of attribute types comprising reading level, literary style, author style, theme, and language.

29. The method of claim 27, wherein the method further comprises:
selecting a jurisdiction-specific classifier to classify the content based on the at least one selected attribute; and
classifying the content with the selected jurisdiction-specific classifier.
